(19) United States
(12) Patent Application Publication
(10) Pub. No.: US 2018/0043393 A1
(43) Pub. Date: Feb. 15, 2018

(54) SYSTEMS AND METHODS FOR TREATING A METAL SUBSTRATE THROUGH THIN FILM PRETREATMENT AND A SEALING COMPOSITION

(71) Applicant: PRC DeSoto International, Inc., Sylmar, CA (US)

(72) Inventors: Kevin T. Sylvester, Lawrence, PA (US); Peter L. Votruba-Drzal, Pittsburgh, PA (US); Elizabeth S. Brown-Tseng, Gibsonia, PA (US); Justin J. Martin, Irwin, PA (US); Shuqi Wang, Tianjin (CN)

(21) Appl. No.: 15/675,833

(22) Filed: Aug. 14, 2017

Related U.S. Application Data
(60) Provisional application No. 62/374,188, filed on Aug. 12, 2016.

(51) Int. Cl. B05D 1/02; B05D 1/28; B05D 3/00; B05D 1/18

(52) U.S. Cl. CPC B05D 1/02; B05D 1/18; B05D 1/28; B05D 3/002

(57) ABSTRACT

Disclosed herein is a system for treating a substrate. The system includes a pretreatment composition for treating at a least a portion of the substrate, the pretreatment composition comprising a Group IVB metal cation; and a sealing composition for treating at least a portion of the substrate treated with the pretreatment composition, the sealing composition comprising a Group IA metal cation. Also disclosed are methods of treated a substrate with the system. Also disclosed are substrates treated with the system and method.

### CROSS-REFERENCE TO RELATED APPLICATION

This application claims priority to U.S. Provisional Application No. 62/374,188 entitled “Sealing Composition” and filed on Aug. 12, 2016, incorporated herein in its entirety by reference.

### FIELD

The present invention relates to systems and methods for treating a metal substrate. The present invention also relates to a coated metal substrate.

### BACKGROUND

The use of protective coatings on metal substrates for improved corrosion resistance and paint adhesion is common. Conventional techniques for coating such substrates include techniques that involve pretreating the metal substrate with chromium-containing compositions. The use of such chromate-containing compositions, however, imparts environmental and health concerns.

As a result, chromate-free pretreatment compositions have been developed. Such compositions are generally based on chemical mixtures that react with the substrate surface and bind to it to form a protective layer. For example, pretreatment compositions based on a Group IVB metals have become more prevalent. Such compositions often contain a source of free fluoride, i.e., fluoride available as isolated ions in the pretreatment composition as opposed to fluoride that is bound to another element, such as a Group IVB metal. Free fluoride can etch the surface of the metal substrate, thereby promoting deposition of a Group IVB metal coating. Nevertheless, the corrosion resistance capability of these pretreatment compositions has generally been inferior to conventional chromium-containing pretreatments.

A skilled artisan knows tricationic zinc phosphate, another type of pretreatment, provides excellent corrosion performance over steel and zinc coated steel substrates. The term tricationic indicated the inclusion of zinc metal ions, nickel metal ions, and manganese metals ions in zinc phosphate pretreatment compositions. In general zinc phosphate is either superior or equivalent to Group IVB metal-based pretreatment technologies on steel and zinc coated steel substrates. However, there are some drawbacks to employing tricationic zinc phosphate as the pretreatment stage in a multimetal vehicle line. Namely, the high temperature required for application, the necessity for an activation step, the requirement for nickel in the pretreatment formulation. Zinc phosphate pretreatment suffers from limitations on certain substrates including limits on aluminum content and difficulty coating certain high strength steel alloys. The high application temperature and activator step make the customer incur higher operational costs, which are mitigated by the use of Group IVB pretreatments. Group IVB pretreatment technologies do not require an activating step and the process is run at ambient temperature. Heavy metals, e.g. nickel, are generally absent from the Group IVB formulations. These technologies can efficiently coat high levels of aluminum in a multimetal vehicle as well as many high strength steel substrates. If the performance of Group IVB pretreatments are improved, adoption of this technology would be more wide spread.

It would be desirable to provide compositions and methods for treating a metal substrate that overcome at least some of the previously described drawbacks of the prior art, including the environmental drawbacks associated with the use of chromates and tricationic zinc phosphate. It also would be desirable to provide compositions and methods for treating metal substrates that impart corrosion resistance and adhesion properties that are equivalent to, or even superior to, the corrosion resistance and adhesion properties imparted through the use of zinc phosphate- or chromium-containing pretreatment coatings. It would also be desirable to provide related coated metal substrates.

Hot dipped galvanized (HDG) steel offers significant corrosion protection over uncoated steel substrates. Zinc is less noble than the underlying steel (iron) and will oxidize over time forming a passivating zinc oxide layer. Exposure to atmospheric conditions will facilitate the formation of zinc carbonate by a chemical reaction between zinc oxide (corrosion product) and atmospheric carbon dioxide. Zinc carbonate facilitates better paint adhesion, as newly produced HDG often suffers from poor adhesion of organic coatings to the metal surface. Aging the substrate prior to paint application is one mechanism is to overcome the challenge of poor adhesion. However, aging is an impractical approach for improving adhesion since many applications have a cleaning and pretreatment stage that will remove the protective zinc carbonate. Improvements in the performance of Group IVB pretreatments would allow the corrosion benefits of HDG to be realized with the environmental and process advantages of Group IVB pretreatments

### SUMMARY

Disclosed herein is a system for treating a substrate comprising: a pretreatment composition for treating at a least a portion of the substrate, the pretreatment composition comprising a Group IVB metal cation; and a sealing composition for treating at least a portion of the substrate treated with the pretreatment composition, the sealing composition comprising a Group IA metal cation.

Also disclosed herein is a method of treating a substrate comprising: contacting at least a portion of the substrate surface with a pretreatment composition comprising a Group IVB metal cation; and contacting at least a portion of the substrate surface with a sealing composition for treating at least a portion of the substrate treated with the pretreatment composition, the sealing composition comprising a Group IA metal cation; wherein the contacting with the pretreatment composition occurs prior to the contacting with the sealing composition.

Also disclosed are substrates obtainable by the system and/or method of treating.

### BRIEF DESCRIPTION OF THE DRAWINGS

FIG. 1 is an example composition of deposited Group IVB pretreatment layer as measured by XPS depth profiling.

FIG. 2 is a comparison of fluoride to oxide ratio as a function of depth showing the decreasing in fluoride content when comparing the pretreatment/air interface to the substrate/pretreatment interface.

FIG. 3 is a schematic of the transition between fluoride-rich (near pretreatment air/interface) to oxygen-rich (near pretreatment/substrate interface) for a deposited Group IVB pretreatment layer.

FIG. 4 is zirconium XPS depth profiles of HDG panels pretreated with Zr and rinsed with DI water or sealed with a sealing composition of the present invention.

FIG. 5 is fluoride XPS depth profiles of HDG panels pretreated with Zr metal cations and rinsed with DI water or sealed with a sealing composition of the present invention.

FIG. 6 is ratios of F:Zr XPS depth profiles of HDG panels pretreated with Zr metal cations and rinsed with either DI water or sealed with the sealing composition of the present invention. Calculating the ratio of the fluoride wt. % to the zirconium wt. % and plotting as a function of pretreatment depth clearly highlights the reduction in fluoride content of the deposited pretreatment film when treated with a sealing composition of the present invention.

FIG. 7 is zirconium XPS depth profiles of HDG panels pretreated with Zr metal cations and rinsed with DI water or sealed with a sealing composition of the present invention.

FIG. 8 is fluoride XPS depth profiles of HDG panels pretreated with Zr metal cations and rinsed with DI water or sealed with a sealing composition of the present invention.

FIG. 9 is ratios of F:Zr XPS depth profiles of HDG panels pretreated with Zr metal cations and rinses with DI water or sealed with SC-4, SC-5, or SC-6. Calculating the ratio of the fluoride wt. % to the zirconium wt. % and plotting as a function of pretreatment depth clearly highlights the reduction in fluoride content of the deposited pretreatment film when treated with a sealing composition of the present invention.

FIG. 10a shows a galvanized steel panel having a galvanized (zinc) coating over the entire surface of the panel. FIG. 10b shows a galvanized panel wherein an orbital sander was used to remove zinc in an oval shape and expose the underlying iron substrate on the panel. The ridge area is comprised of a mixture of steel (iron) and zinc.

### DETAILED DESCRIPTION

As mentioned above, the present invention is directed to a system and method for treating a metal substrate comprising, or in some instances, consisting essentially of, or in some instances, consisting of: a pretreatment composition for treating at least a portion of the substrate, the pretreatment composition comprising, or in some instances, consisting essentially of, or in some instances, consisting of, a Group IVB metal cation; and a sealing composition for treating at least a portion of the substrate, the sealing composition comprising, or in some instances, consisting essentially of, or in some instances, consisting of, a Group IA metal cation. According to the present invention, as set forth in more detail below, the system may be substantially free, or in some instances essentially free, or in some instances completely free, of chromium or chromium-containing compounds (defined below) and/or phosphate ions and/or phosphate-containing compounds (defined below).

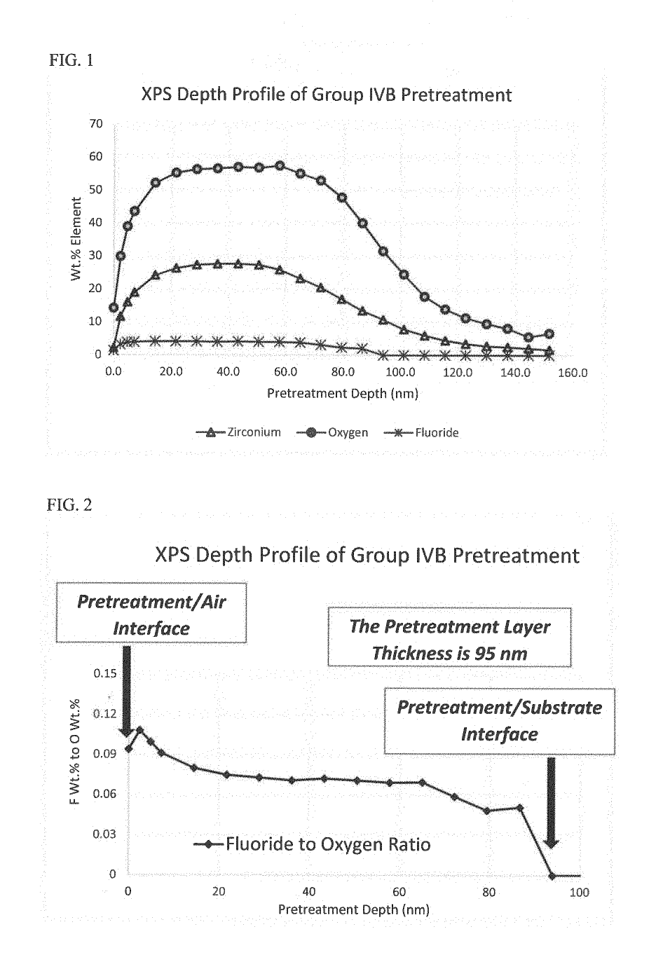

The person skilled in the art of substrate protection understands that the chemical composition of a deposited Group IVB-based pretreatment layer can be variable. In regions of the pretreatment layer near the substrate/pretreatment interface, the composition is known to be rich in oxygen and deficient in fluoride. When the composition of the pretreatment is analyzed near the pretreatment/air interface, a reduction in the concentration of oxygen and a higher concentration of fluoride is typically observed. While not wishing to be bound by theory, it is believed that this difference in composition results from the pH gradient that occurs during the pretreatment process. At longer distances from the pretreatment/substrate interface, the local pH is known to be closer to the bulk pH. When the local pH is close to the bulk pH the fluoride/(hydr)oxide metathesis that drives Group IVB-based pretreatment deposition will be less efficient. It has been discovered herein that, with this reduction in pH differences, the resulting pretreatment film or layer has a higher fluoride concentration as the pretreatment film or layer increases in thickness. See, e.g., FIGS. 1-3. As used herein “pretreatment thickness” is defined as the depth at which the Group IVB atomic wt. % falls below 10% as measured by XPS depth profiling. The pretreatment thickness (as measured in nm) represents the distance from the pretreatment/air interface (0 nm in FIGS. 1-3), and therefore, the larger the thickness of the pretreatment layer, the closer to the substrate/pretreatment interface.

Suitable substrates that may be used in the present invention include metal substrates, metal alloy substrates, and/or substrates that have been metallized, such as nickel plated plastic. According to the present invention, the metal or metal alloy can comprise or be steel, aluminum, zinc, nickel, and/or magnesium. For example, the steel substrate could be cold rolled steel, hot rolled steel, electrogalvanized steel, and/or hot dipped galvanized steel. Aluminum alloys of the 1XXX, 2XXX, 3XXX, 4XXX, 5XXX, 6XXX, or 7XXX series as well as clad aluminum alloys also may be used as the substrate. Aluminum alloys may comprise, for example, 0.01% by weight copper to 10% by weight copper. Aluminum alloys which are treated may also include castings, such as 1XX.X, 2XX.X, 3XX.X, 4XX.X, 5XX.X, 6XX.X, 7XX.X, 8XX.X, or 9XX.X (e.g.: A356.0). Magnesium alloys of the AZ31B, AZ91C, AM60B, or EV31A series also may be used as the substrate. The substrate used in the present invention may also comprise titanium and/or titanium alloys, zinc and/or zinc alloys, and/or nickel and/or nickel alloys. According to the present invention, the substrate may comprise a portion of a vehicle such as a vehicular body (e.g., without limitation, door, body panel, trunk deck lid, roof panel, hood, roof and/or stringers, rivets, landing gear components, and/or skins used on an aircraft) and/or a vehicular frame. As used herein, “vehicle” or variations thereof includes, but is not limited to, civilian, commercial and military aircraft, and/or land vehicles such as cars, motorcycles, and/or trucks.

As mentioned above, the system and method of the present invention may comprise a pretreatment composition. The pretreatment composition may comprise a Group IVB metal cation. The pretreatment composition also may further comprise a Group IA metal cation and/or a Group VIB metal cation (together with the Group IVB metal cation, referred to collectively herein as “pretreatment composition metal cations”).

According to the present invention, the Group IA metal cation may comprise lithium; the Group IVB metal cation may comprise zirconium, titanium, hafnium, or combinations thereof; and the Group VIB metal may comprise molybdenum.

For example, the Group IVB metal cation used in the pretreatment composition may be a compound of zirconium, titanium, hafnium, or a mixture thereof. Suitable compounds of zirconium include, but are not limited to, hexafluorozirconic acid, alkali metal and ammonium salts thereof, ammonium zirconium carbonate, zirconyl nitrate, zirconyl sulfate, zirconium carboxylates and zirconium hydroxy carboxylates, such as zirconium acetate, zirconium oxalate, ammonium zirconium glycolate, ammonium zirconium lactate, ammonium zirconium citrate, zirconium basic carbonate, and mixtures thereof. Suitable compounds of titanium include, but are not limited to, fluorotitanic acid and its salts. A suitable compound of hafnium includes, but is not limited to, hafnium nitrate.

According to the present invention, the Group IVB metal cation may be present in the pretreatment composition in a total amount of at least 20 ppm metal (calculated as metal cation), based on total weight of the pretreatment composition, such as at least 50 ppm metal, or, in some cases, at least 70 ppm metal. According to the present invention, the Group IVB metal may be present in the pretreatment composition in a total amount of no more than 1000 ppm metal (calculated as metal cation), based on total weight of the pretreatment composition, such as no more than 600 ppm metal, or, in some cases, no more than 300 ppm metal. According to the present invention, the Group IVB metal cation may be present in the pretreatment composition in a total amount of 20 ppm metal to 1000 ppm metal (calculated as metal cation), based on total weight of the pretreatment composition, such as from 50 ppm metal to 600 ppm metal, such as from 70 ppm metal to 300 ppm metal. As used herein, the term “total amount,” when used with respect to the amount of Group IVB metal cation, means the sum of all Group IV metals present in the pretreatment composition.

According to the present invention, the pretreatment composition also may comprise a Group IA metal cation such as a lithium cation. According to the invention, the source of Group IA metal cation in the pretreatment composition may be in the form of a salt. Non-limiting examples of suitable lithium salts include lithium nitrate, lithium sulfate, lithium fluoride, lithium chloride, lithium hydroxide, lithium carbonate, lithium iodide, and combinations thereof.

According to the present invention, the Group I metal cation may be present in the pretreatment composition in an amount of at least 2 ppm (as metal cation), based on a total weight of the pretreatment composition, such as at least 5 ppm, such as at least 25 ppm, such as at least 75 ppm, and in some instances, may be present in amount of no more than 500 ppm (as metal cation), based on a total weight of the pretreatment composition, such as no more than 250 ppm, such as no more than 125 ppm, such as no more than 100 ppm. According to the present invention, the Group IA metal cation may be present in the pretreatment composition in an amount of 2 ppm to 500 ppm (as metal cation), based on a total weight of the pretreatment composition, such as 5 ppm to 250 ppm, such as 5 ppm to 125 ppm, such as 5 ppm to 25 ppm. The amount of Group IA metal cation in the pretreatment composition can range between the recited values inclusive of the recited values.

According to the present invention, the pretreatment composition may also comprise a Group VIB metal cation. According to the present invention, the source of Group VIB metal cation in the pretreatment composition may be in the form of a salt. Non-limiting examples of suitable molybdenum salts include sodium molybdate, lithium molybdate, calcium molybdate, potassium molybdate, ammonium molybdate, molybdenum chloride, molybdenum acetate, molybdenum sulfamate, molybdenum formate, molybdenum lactate, and combinations thereof.

According to the present invention, the Group VIB metal cation may be present in the pretreatment composition in an amount of at least 5 ppm (as metal cation), based on a total weight of the pretreatment composition, such as at least 25 ppm, such as 100 ppm, and in some instances, may be present in the pretreatment composition in an amount of no more than 500 ppm (as metal cation), based on total weight of the pretreatment composition, such as no more than 250 ppm, such as no more than 150 ppm. According to the present invention, the Group VIB metal cation may be present in the pretreatment composition in an amount of 5 ppm to 500 ppm (as metal cation), based on total weight of the pretreatment composition, such as 25 ppm to 250 ppm, such as 40 ppm to 120 ppm. The amount of Group VIB metal cation in the pretreatment composition can range between the recited values inclusive of the recited values.

According to the present invention, the pretreatment composition may further comprise an anion that may be suitable for forming a salt with the pretreatment composition metal cations, such as a halogen, a nitrate, a sulfate, a silicate (orthosilicates and metasilicates), carbonates, hydroxides, and the like.

According to the present invention, the nitrate may be present in the pretreatment composition, if at all, in an amount of at least 2 ppm, such as at least 50 ppm, such as at least 50 ppm, (calculated as nitrate anion) based on total weight of the pretreatment composition, and may be present in an amount of no more than 10,000 ppm, such as no more than 5000 ppm, such as no more than 2500 ppm, (calculated as nitrate anion) based on total weight of the pretreatment composition. According to the present invention, the halogen may be present in the pretreatment composition, if at all, in an amount of 2 ppm to 10,000 ppm, such as 25 ppm to 5000 ppm, such as 50 ppm to 2500 ppm, (calculated as nitrate anion) based on total weight of the pretreatment composition.

According to the present invention, the pretreatment composition also may comprise an electropositive metal ion. As used herein, the term “electropositive metal ion” refers to metal ions that will be reduced by the metal substrate being treated when the pretreatment solution contacts the surface of the metallic substrate. As will be appreciated by one skilled in the art, the tendency of chemical species to be reduced is called the reduction potential, is expressed in volts, and is measured relative to the standard hydrogen electrode, which is arbitrarily assigned a reduction potential of zero. The reduction potential for several elements is set forth in Table 1 below (according to the CRC 82^{nd} Edition, 2001-2002). An element or ion is more easily reduced than another element or ion if it has a voltage value, E*, in the following table, that is more positive than the elements or ions to which it is being compared.

TABLE 1

| Element | Reduction half-cell reaction | Voltage, E* |
|---|---|---|
| Potassium | K⁺ + e → K | −2.93 |
| Calcium | Ca²⁺ + 2e → Ca | −2.87 |
| Sodium | Na⁺ + e → Na | −2.71 |
| Magnesium | Mg²⁺ + 2e → Mg | −2.37 |
| Aluminum | Al³⁺ + 3e → Al | −1.66 |
| Zinc | Zn²⁺ + 2e → Zn | −0.76 |
| Iron | Fe²⁺ + 2e → Fe | −0.45 |
| Nickel | Ni²⁺ + 2e → Ni | −0.26 |
| Tin | Sn²⁺ + 2e → Sn | −0.14 |
| Lead | Pb²⁺ + 2e → Pb | −0.13 |
| Hydrogen | 2H⁺ + 2e → H₂ | −0.00 |
| Copper | Cu²⁺ + 2e → Cu | 0.34 |
| Mercury | Hg₂²⁺ + 2e → 2Hg | 0.80 |
| Silver | Ag⁺ + e → Ag | 0.80 |
| Gold | Au³⁺ + 3e → Au | 1.50 |

Thus, as will be apparent, when the metal substrate comprises one of the materials listed earlier, such as cold rolled steel, hot rolled steel, steel coated with zinc metal, zinc compounds, or zinc alloys, hot-dipped galvanized steel, galvanealed steel, steel plated with zinc alloy, aluminum alloys, aluminum plated steel, aluminum alloy plated steel, magnesium and magnesium alloys, suitable electropositive metal ions for deposition thereon include, for example, nickel, copper, silver, and gold, as well mixtures thereof.

According to the present invention, when the electropositive metal ion comprises copper, both soluble and insoluble compounds may serve as a source of copper ions in the pretreatment compositions. For example, the supplying source of copper ions in the pretreatment composition may be a water soluble copper compound. Specific examples of such compounds include, but are not limited to, copper sulfate, copper nitrate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper lactate, copper oxalate, copper tartrate, copper malate, copper succinate, copper malonate, copper maleate, copper benzoate, copper salicylate, copper amino acid complexes, copper fumarate, copper glycerophosphate, sodium copper chlorophyllin, copper fluorosilicate, copper fluoroborate and copper iodate, as well as copper salts of carboxylic acids such as in the homologous series formic acid to decanoic acid, and copper salts of polybasic acids in the series oxalic acid to suberic acid.

When copper ions supplied from such a water-soluble copper compound are precipitated as an impurity in the form of copper sulfate, copper oxide, etc., it may be desirable to add a complexing agent that suppresses the precipitation of copper ions, thus stabilizing them as a copper complex in the composition.

According to the present invention, the copper compound may be added as a copper complex salt such as or Cu-EDTA, which can be present stably in the pretreatment composition on its own, but it is also possible to form a copper complex that can be present stably in the pretreatment composition by combining a complexing agent with a compound that is difficult to solubilize on its own. An example thereof includes a Cu-EDTA complex formed by a combination of CuSO₄ and EDTA.2Na.

According to the present invention, the electropositive metal ion may be present in the pretreatment composition in an amount of at least 2 ppm (calculated as metal ion), based on the total weight of the pretreatment composition, such as at least 4 ppm, such as at least 6 ppm, such as at least 8 ppm, such as at least 10 ppm. According to the present invention, the electropositive metal ion may be present in the pretreatment composition in an amount of no more than 100 ppm (calculated as metal ion), based on the total weight of the pretreatment composition, such as no more than 80 ppm, such as no more than 60 ppm, such as no more than 40 ppm, such as no more than 20 ppm. According to the present invention, the electropositive metal ion may be present in the pretreatment composition in an amount of from 2 ppm to 100 ppm (calculated as metal ion), based on the total weight of the pretreatment composition, such as from 4 ppm to 80 ppm, such as from 6 ppm to 60 ppm, such as from 8 ppm to 40 ppm, The amount of electropositive metal ion in the pretreatment composition can range between the recited values inclusive of the recited values.

According to the present invention, a source of fluoride may be present in the pretreatment composition. As used herein the amount of fluoride disclosed or reported in the pretreatment composition is referred to as “free fluoride,” as measured in part per millions of fluoride. Free fluoride is defined herein as being able to be measured by a fluoride-selective ISE. In addition to free fluoride, a pretreatment may also contain “bound fluoride, which is described above. The sum of the concentrations of the bound and free fluoride equal the total fluoride, which can be determined as described herein. The total fluoride in the pretreatment composition can be supplied by hydrofluoric acid, as well as alkali metal and ammonium fluorides or hydrogen fluorides. Additionally, total fluoride in the pretreatment composition may be derived from Group IVB metals present in the pretreatment composition, including, for example, hexafluorozirconic acid or hexafluorotitanic acid. Other complex fluorides, such as H₂SiF₆ or HBF₄, can be added to the pretreatment composition to supply total fluoride. The skilled artisan will understand that the presence of free fluoride in the pretreatment bath can impact pretreatment deposition and etching of the substrate, hence it is critical to measure this bath parameter. The levels of free fluoride will depend on the pH and the addition of chelators into the pretreatment bath and indicates the degree of fluoride association with the metal ions/protons present in the pretreatment bath. For example, pretreatment compositions of identical total fluoride levels can have different free fluoride levels which will be influenced by the pH and chelators present in the pretreatment solution.

According to the present invention, the free fluoride of the pretreatment composition may be present in an amount of at least 15 ppm, based on a total weight of the pretreatment composition, such as at least 50 ppm free fluoride, such as at least 100 ppm free fluoride, such as at least 200 ppm free fluoride. According to the present invention, the free fluoride of the pretreatment composition may be present in an amount of no more than 2500 ppm, based on a total weight of the pretreatment composition, such as no more than 1000 ppm free fluoride, such as no more than 500 ppm free fluoride, such as no more than 250 ppm free fluoride. According to the present invention, the free fluoride of the pretreatment composition may be present in an amount of 15 ppm free fluoride to 2500 ppm free fluoride, based on a total weight of the pretreatment composition, such as 50 ppm fluoride to 1000 ppm, such as no more than 200 ppm free fluoride to 500 ppm free fluoride, such as no more than 100 ppm free fluoride to 250 ppm free fluoride.

According to the present invention, the pretreatment composition may, in some instances, comprise an adhesion promoter. As used herein, the term “adhesion promoter” refers to a chemical species that has at least two binding sites (difunctional) to facilitate interaction (whether electrostatic, covalent, or adsorption) between the pretreated surface and subsequent coating layers or to enhance cohesive bonding within the pretreatment layer by co-depositing during the deposition of the pretreatment film. Non-limiting examples of the adhesion promoter include carboxylates, phosphonates, silanes, sulfonates, anhydrides, titanates, zirconates, unsaturated fatty acids, functionalized amines, phosphonic acids, functionalized thiols, carboxylic acids, polycarboxylic acid, bisphosphonic acids, poly(acrylic) acid, or combinations thereof. According to the present invention, the adhesion promoter may have a molecular weight of 200 to 20,000, such as 500 to 5000, such as 1000 to 3000. Commercially available products include, for example, Acumer 1510 (available from Dow), and Dispex Ultra 4585, 4580 and 4550 (available from BASF). According to the present invention, the adhesion promoter may be present in the pretreatment composition in an amount of 10 ppm to 10,000 ppm, such as 15 ppm to 1500 ppm, such as 20 ppm to 1000 ppm, such 25 to 500 ppm

According to the present invention, the pretreatment composition may, in some instances, comprise an oxidizing agent. Non-limiting examples of the oxidizing agent include peroxides, persulfates, perchlorates, chlorates, hypochlorite, nitric acid, sparged oxygen, bromates, peroxi-benzoates, ozone, or combinations thereof. According to the present invention, the oxidizing agent may be present, if at all, in an amount of at least 50 ppm, such as at least 500 ppm, based on total weight of the pretreatment composition, and in some instances, may be present in an amount of no more than 13,000 ppm, such as no more than 3000 ppm, based on total weight of the pretreatment composition. In some instances, the oxidizing agent may be present in the pretreatment composition, if at all, in an amount of 100 ppm to 13,000 ppm, such as 500 ppm to 3000 ppm, based on total weight of the pretreatment composition. As used herein, the term “oxidizing agent,” when used with respect to a component of the pretreatment composition, refers to a chemical which is capable of oxidizing at least one of: a metal present in the substrate which is contacted by the pretreatment composition, and/or a metal-complexing agent present in the pretreatment composition. As used herein with respect to “oxidizing agent,” the phrase “capable of oxidizing” means capable of removing electrons from an atom or a molecule present in the substrate or the pretreatment composition, as the case may be, thereby decreasing the number of electrons of such atom or molecule.

According to the present invention, the pretreatment composition may exclude chromium or chromium-containing compounds. As used herein, the term “chromium-containing compound” refers to materials that include trivalent and/or hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, strontium dichromate, chromium(III) sulfate, chromium(III) chloride, and chromium(III) nitrate. When a pretreatment composition and/or a coating or a layer, respectively, formed from the same is substantially free, essentially free, or completely free of chromium, this includes chromium in any form, such as, but not limited to, the trivalent and hexavalent chromium-containing compounds listed above.

Thus, optionally, according to the present invention, the present pretreatment compositions and/or coatings or layers, respectively, deposited from the same may be substantially free, may be essentially free, and/or may be completely free of one or more of any of the elements or compounds listed in the preceding paragraph. A pretreatment composition and/or coating or layer, respectively, formed from the same that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the pretreatment composition; in the case of chromium, this may further include that the element or compounds thereof are not present in the pretreatment compositions and/or coatings or layers, respectively, formed from the same in such a level that it causes a burden on the environment. The term “substantially free” means that the pretreatment compositions and/or coating or layers, respectively, formed from the same contain less than 10 ppm of any or all of the elements or compounds listed in the preceding paragraph, based on total weight of the composition or the layer, respectively, if any at all. The term “essentially free” means that the pretreatment compositions and/or coatings or layers, respectively, formed from the same contain less than 1 ppm of any or all of the elements or compounds listed in the preceding paragraph, if any at all. The term “completely free” means that the pretreatment compositions and/or coatings or layers, respectively, formed from the same contain less than 1 ppb of any or all of the elements or compounds listed in the preceding paragraph, if any at all.

According to the present invention, the pretreatment composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a layer or coating comprising the same is substantially free, essentially free, or completely free of phosphate, this includes phosphate ions or compounds containing phosphate in any form.

Thus, according to the present invention, pretreatment composition and/or layers deposited from the same may be substantially free, or in some cases may be essentially free, or in some cases may be completely free, of one or more of any of the ions or compounds listed in the preceding paragraph. A pretreatment composition and/or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the pretreatment compositions and/or layers deposited from the same in such a level that they cause a burden on the environment. The term “substantially free” means that the pretreatment compositions and/or layers deposited from the same contain less than 5 ppm of any or all of the phosphate anions or compounds listed in the preceding paragraph, based on total weight of the composition or the layer, respectively, if any at all. The term “essentially free” means that the pretreatment compositions and/or layers comprising the same contain less than 1 ppm of any or all of the phosphate anions or compounds listed in the preceding paragraph. The term “completely free” means that the pretreatment compositions and/or layers comprising the same contain less than 1 ppb of any or all of the phosphate anions or compounds listed in the preceding paragraph, if any at all.

Optionally, according to the present invention, the pretreatment composition may further comprise a source of phosphate ions. For clarity, when used herein, “phosphate ions” refers to phosphate ions that derive from or originate from inorganic phosphate compounds. For example, in some instances, phosphate ions may be present in an amount of greater than 5 ppm, based on total weight of the pretreatment composition, such as 10 ppm, such as 20 ppm. In some instances, phosphate ions may be present in an amount of no more than 60 ppm, based on total weight of the pretreatment composition, such as no more than 40 ppm, such as no more than 30 ppm. In some instances, phosphate ions may be present in an amount of from 5 ppm to 60 ppm, based on total weight of the pretreatment composition, such as from 10 ppm to 40 ppm, such as from 20 ppm to 30 ppm.

According to the present invention, the pH of the pretreatment composition may be 6.5 or less, such as 5.5 or less, such as 4.5 or less, such as 3.5 or less. According to the present invention, the pH of the pretreatment composition may, in some instances, be 2.0 to 6.5, such as 3 to 4.5, and may be adjusted using, for example, any acid and/or base as is necessary. According to the present invention, the pH of the pretreatment composition may be maintained through the inclusion of an acidic material, including water soluble and/or water dispersible acids, such as nitric acid, sulfuric acid, and/or phosphoric acid. According to the present invention, the pH of the composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

According to the present invention, the pretreatment composition also may further comprise a resinous binder. Suitable resins include reaction products of one or more alkanolamines and an epoxy-functional material containing at least two epoxy groups, such as those disclosed in U.S. Pat. No. 5,653,823. In some cases, such resins contain beta hydroxy ester, imide, or sulfide functionality, incorporated by using dimethylolpropionic acid, phthalimide, or mercaptoglycerine as an additional reactant in the preparation of the resin. Alternatively, the reaction product can for instance be that of the diglycidyl ether of Bisphenol A (commercially available e.g. from Shell Chemical Company as EPON 880), dimethylol propionic acid, and diethanolamine in a 0.6 to 5.0:0.05 to 5.5:1 mole ratio. Other suitable resinous binders include water soluble and water dispersible polyacrylic acids such as those disclosed in U.S. Pat. Nos. 3,912,548 and 5,328,525; phenol formaldehyde resins such as those described in U.S. Pat. No. 5,662,746; water soluble polyamides such as those disclosed in WO 95/33869; copolymers of maleic or acrylic acid with allyl ether such as those described in Canadian patent application 2,087,352; and water soluble and dispersible resins including epoxy resins, aminoplasts, phenol-formaldehyde resins, tannins, and polyvinyl phenols such as those discussed in U.S. Pat. No. 5,449,415

According to the present invention, the resinous binder often may be present in the pretreatment composition in an amount of 0.005 percent to 30 percent by weight, such as 0.5 to 3 percent by weight, based on the total weight of the composition. Alternatively, according to the present invention, the pretreatment composition may be substantially free or, in some cases, completely free of any resinous binder. As used herein, the term “substantially free”, when used with reference to the absence of resinous binder in the pretreatment composition, means that, if present at all, any resinous binder is present in the pretreatment composition in a trace amount of less than 0.005 percent by weight, based on total weight of the composition. As used herein, the term “completely free” means that there is no resinous binder in the pretreatment composition at all.

The pretreatment composition may comprise an aqueous medium and may optionally contain other materials such as nonionic surfactants and auxiliaries conventionally used in the art of pretreatment compositions. In the aqueous medium, water dispersible organic solvents, for example, alcohols with up to about 8 carbon atoms such as methanol, isopropanol, and the like, may be present; or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the pretreatment composition.

Optionally, according to the present invention, the pretreatment composition and/or films deposited or formed therefrom may further comprise silicon, such as silanes, silicas, silicates, and the like, in amounts of at least 10 ppm, based on total weight of the pretreatment composition, such as at least 20 ppm, such as at least 50 ppm. According to the present invention, the pretreatment composition and/or films deposited or formed therefrom may comprise silicon in amounts of less than 500 ppm, based on total weight of the pretreatment composition, such as less than 250 ppm, such as less than 100 ppm. According to the present invention, the pretreatment composition and/or films deposited or formed therefrom may comprise silicon in amounts of 10 ppm to 500 ppm, based on total weight of the pretreatment composition, such as 20 ppm to 250 ppm, such as 50 ppm to 100 ppm. Alternatively, the pretreatment composition of the present invention and/or films deposited or formed therefrom may be substantially free, or, in some cases, completely free of silicon.

The pretreatment composition may comprise a carrier, often an aqueous medium, so that the composition is in the form of a solution or dispersion of the Group IVB metal in the carrier. According to the present invention, the solution or dispersion may be brought into contact with the substrate by any of a variety of known techniques, such as dipping or immersion, spraying, intermittent spraying, dipping followed by spraying, spraying followed by dipping, brushing, or roll-coating. According to the invention, the solution or dispersion when applied to the metal substrate is at a temperature ranging from 40° F. to 185° F., such as 60° F. to 110° F., such as 70° F. to 90° F. For example, the pretreatment process may be carried out at ambient or room temperature. The contact time is often from 5 seconds to 15 minutes, such as 10 seconds to 10 minutes, such as 15 seconds to 3 minutes.

Following the contacting with the pretreatment composition, the substrate may be rinsed with tap water, deionized water, and/or an aqueous solution of rinsing agents in order to remove any residue. The substrate optionally may be air dried at room temperature or may be dried with hot air, for example, by using an air knife, by flashing off the water by brief exposure of the substrate to a high temperature, such as by drying the substrate in an oven at 15° C. to 200° C., such as 20° C. to 90° C., or in a heater assembly using, for example, infrared heat, such as for 10 minutes at 70° C., or by passing the substrate between squeegee rolls. According to the present invention, following the contacting with the pretreatment composition, the substrate optionally may be rinsed with tap water, deionized water, and/or an aqueous solution of rinsing agents in order to remove any residue and then optionally may be dried, for example air dried or dried with hot air as described in the preceding sentence.

According to the present invention the film coverage of the residue of the pretreatment coating composition generally ranges typically from 1 to 1000 milligrams per square meter (mg/m²), for example, from 10 to 400 mg/m². The thickness of the pretreatment coating may for instance be less than 1 micrometer, for example from 1 to 500 nanometers, or from 10 to 300 nanometers. Coating weights may be determined by removing the film from the substrate and determining the elemental composition using a variety of analytical techniques (such as XRF, ICP, etc.). Pretreatment thickness can be determined using a handful of analytical techniques including, but not limited to XPS depth profiling or TEM.

As mentioned above, the present invention also comprises a sealing composition. The sealing composition may comprise a Group IA metal cation. According to the invention, the Group IA metal cation may be lithium, sodium, potassium, rubidium, cesium cations or combinations thereof.

The Group IA metal cation may be supplied as a salt. Nonlimiting examples of anions suitable for forming a salt with Group IA metal cation include carbonates, hydroxides, nitrates, halogens, sulfates, phosphates and silicates (e.g., orthosilicates and metasilicates) such that the metal salt may comprise a carbonate, an hydroxide, a nitrate, a halide, a sulfate, a phosphate, a silicate (e.g., orthosilicate or metasilicate), a permanganate, a chromate, a vanadate, a molybdate, a tetraborate and/or a perchlorate.

According to the present invention, the Group IA metal salt of the present invention may comprise an inorganic Group IA metal salt, an organic Group IA metal salt, or combinations thereof. According to the present invention, the anion and the cation of the Group IA metal salt both may be soluble in water. According to the present invention, for example, the lithium salt may have a solubility constant in water at a temperature of 25° C. (K; 25° C.) of at least 1×10⁻¹¹, such as least 1×10⁻⁴, and in some instances, may be no more than 5×10⁺². According to the present invention, the lithium salt may have a solubility constant in water at a temperature of 25° C. (K;25° C.) of 1×10⁻¹¹ to 5×10⁺², such as 1×10⁻⁴ to 5×10⁺². As used herein, “solubility constant” means the product of the equilibrium concentrations of the ions in a saturated aqueous solution of the respective lithium salt. Each concentration is raised to the power of the respective coefficient of ion in the balanced equation. The solubility constants for various salts can be found in the Handbook of Chemistry and Physics.

According to the present invention, the Group IA metal cation may be present in the sealing composition in an amount of at least 5 ppm (calculated as metal cation) based on total weight of the sealing composition, such as at least 50 ppm, such as at least 150 ppm, such as at least 250 ppm, and in some instances, may be present in an amount of no more than 10,000 ppm (calculated as metal cation) based on total weight of the sealing composition, such as no more than 5500 ppm, such as no more than 2500 ppm, such as no more than 1000 ppm. In some instances, according to the present invention, the Group IA metal cation may be present in the sealing composition in an amount of 5 ppm to 10,000 ppm (calculated as metal cation) based on total weight of the sealing composition, such as 50 ppm to 7500 ppm, such as 150 ppm to 6500 ppm, such as 250 ppm to 5000 ppm.

According to the present invention, the sealing composition may exclude Group IIA metal cations or Group IIA metal-containing compounds, including but not limited to calcium. Non-limiting examples of such materials include Group IIA metal hydroxides, Group IIA metal nitrates, Group IIA metal halides, Group IIA metal sulfamates, Group IIA metal sulfates, Group IIA carbonates and/or Group IIA metal carboxylates. When a sealing composition and/or a coating or a layer, respectively, formed from the same is substantially free, essentially free, or completely free of a Group IIA metal cation, this includes Group IIA metal cations in any form, such as, but not limited to, the Group IIA metal-containing compounds listed above.

According to the present invention, the sealing composition may exclude chromium or chromium-containing compounds. As used herein, the term “chromium-containing compound” refers to materials that include trivalent and/or hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate. Non-limiting examples of chromium(III) compound include chromium(III) sulfate, chromium(III) nitrate, and chromium(III) chloride. When a sealing composition and/or a coating or a layer formed from the same is substantially free, essentially free, or completely free of chromium, this includes chromium in any form, such as, but not limited to, the trivalent and hexavalent chromium-containing compounds listed above.

Thus, optionally, according to the present invention, the present sealing compositions and/or coatings or layers deposited from the same may be substantially free, may be essentially free, and/or may be completely free of one or more of any of the elements or compounds listed in the preceding paragraph. A sealing composition and/or coating or layer formed from the same that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the sealing composition; in the case of chromium, this may further include that the element or compounds thereof are not present in the sealing compositions and/or coatings or layers, respectively, formed from the same in such a level that it causes a burden on the environment. The term “substantially free” means that the sealing compositions and/or coating or layers formed from the same contain less than 10 ppm of any or all of the elements or compounds listed in the preceding paragraph, based on total weight of the composition or the layer, if any at all. The term “essentially free” means that the sealing compositions and/or coatings or layers formed from the same contain less than 1 ppm of any or all of the elements or compounds listed in the preceding paragraph, if any at all. The term “completely free” means that the sealing compositions and/or coatings or layers formed from the same contain less than 1 ppb of any or all of the elements or compounds listed in the preceding paragraph, if any at all.

According to the present invention, the sealing composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a layer or coating comprising the same is substantially free, essentially free, or completely free of phosphate, this includes phosphate ions or compounds containing phosphate in any form.

Thus, according to the present invention, sealing composition and/or layers deposited from the same may be substantially free, or in some cases may be essentially free, or in some cases may be completely free, of one or more of any of the ions or compounds listed in the preceding paragraph. A sealing composition and/or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the sealing compositions and/or layers deposited from the same in such a level that they cause a burden on the environment. The term “substantially free” means that the sealing compositions and/or layers deposited from the same contain less than 5 ppm of any or all of the phosphate anions or compounds listed in the preceding paragraph, based on total weight of the composition or the layer, respectively, if any at all. The term “essentially free” means that the sealing compositions and/or layers comprising the same contain less than 1 ppm of any or all of the phosphate anions or compounds listed in the preceding paragraph. The term “completely free” means that the sealing compositions and/or layers comprising the same contain less than 1 ppb of any or all of the phosphate anions or compounds listed in the preceding paragraph, if any at all.

According to the present invention, the sealing composition may, in some instances, exclude fluoride or fluoride sources. As used herein, “fluoride sources” include monofluorides, bifluorides, fluoride complexes, and mixtures thereof known to generate fluoride ions. When a composition and/or a layer or coating comprising the same is substantially free, essentially free, or completely free of fluoride, this includes fluoride ions or fluoride sources in any form, but does not include unintentional fluoride that may be present in a bath as a result of, for example, carry-over from prior treatment baths in the processing line, municipal water sources (e.g.: fluoride added to water supplies to prevent tooth decay), fluoride from a pretreated substrate, or the like. That is, a bath that is substantially free, essentially free, or completely free of fluoride, may have unintentional fluoride that may be derived from these external sources, even though the composition used to make the bath prior to use on the processing line was substantially free, essentially free, or completely free of fluoride.

For example, the sealing composition may be substantially free of any fluoride-sources, such as ammonium and alkali metal fluorides, acid fluorides, fluoroboric, fluorosilicic, fluorotitanic, and fluorozirconic acids and their ammonium and alkali metal salts, and other inorganic fluorides, nonexclusive examples of which are: zinc fluoride, zinc aluminum fluoride, titanium fluoride, zirconium fluoride, nickel fluoride, ammonium fluoride, sodium fluoride, potassium fluoride, and hydrofluoric acid, as well as other similar materials known to those skilled in the art.

Fluoride present in the sealing composition that is not bound to metals ions such as Group IVB metal ions, or hydrogen ion, defined herein as “free fluoride,” may be measured as an operational parameter in the sealing composition bath using, for example, an Orion Dual Star Dual Channel Benchtop Meter equipped with a fluoride ion selective electrode (“ISE”) available from Thermoscientific, the Symphony® Fluoride Ion Selective Combination Electrode supplied by VWR International, or similar electrodes. See, e.g., Light and Cappuccino, Determination of fluoride in toothpaste using an ion-selective electrode, J. Chem. Educ., 52:4, 247-250, April 1975. The fluoride ISE may be standardized by immersing the electrode into solutions of known fluoride concentration and recording the reading in millivolts, and then plotting these millivolt readings in a logarithmic graph. The millivolt reading of an unknown sample can then be compared to this calibration graph and the concentration of fluoride determined. Alternatively, the fluoride ISE can be used with a meter that will perform the calibration calculations internally and thus, after calibration, the concentration of the unknown sample can be read directly.

Fluoride ion is a small negative ion with a high charge density, so in aqueous solution it is frequently complexed with metal ions having a high positive charge density, such as Group IVB metal ions, or with hydrogen ion. Fluoride anions in solution that are ionically or covalently bound to metal cations or hydrogen ion are defined herein as “bound fluoride.” The fluoride ions thus complexed are not measurable with the fluoride ISE unless the solution they are present in is mixed with an ionic strength adjustment buffer (e.g.: citrate anion or EDTA) that releases the fluoride ions from such complexes. At that point (all of) the fluoride ions are measurable by the fluoride ISE, and the measurement is known as “total fluoride”. Alternatively, the total fluoride can be calculated by comparing the weight of the fluoride supplied in the sealer composition by the total weight of the composition.

According to the present invention, the treatment composition may, in some instances, be substantially free, or in some instances, essentially free, or in some instances, completely free, of cobalt ions or cobalt-containing compounds. As used herein, “cobalt-containing compounds” include compounds, complexes or salts containing the element cobalt such as, for example, cobalt sulfate, cobalt nitrate, cobalt carbonate and cobalt acetate. When a composition and/or a layer or coating comprising the same is substantially free, essentially free, or completely free of cobalt, this includes cobalt ions or compounds containing cobalt in any form.

According to the present invention, the treatment composition may, in some instances, be substantially free, or in some instances, essentially free, or in some instances, completely free, of vanadium ions or vanadium-containing compounds. As used herein, “vanadium-containing compounds” include compounds, complexes or salts containing the element vanadium such as, for example, vanadates and decavanadates that include counterions of alkali metal or ammonium cations, including, for example, sodium ammonium decavanadate. When a composition and/or a layer or coating comprising the same is substantially free, essentially free, or completely free of vanadium, this includes vanadium ions or compounds containing vanadium in any form.

According to the present invention, the sealing composition may comprise an aqueous medium and optionally may contain other materials such as at least one organic solvent. Nonlimiting examples of suitable such solvents include propylene glycol, ethylene glycol, glycerol, low molecular weight alcohols, and the like. When present, if at all, the organic solvent may be present in the sealing composition in an amount of at least 1 g solvent per liter of sealing composition, such as at least about 2 g solvent per liter of sealing solution, and in some instances, may be present in an amount of no more than 40 g solvent per liter of sealing composition, such as no more than 20 g solvent per liter of sealing solution. According to the present invention, the organic solvent may be present in the sealing composition, if at all, in an amount of 1 g solvent per liter of sealing composition to 40 g solvent per liter of sealing composition, such as 2 g solvent per liter of sealing composition to 20 g solvent per liter of sealing composition. Other optional materials include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the sealing composition.

According to the present invention, the pH of the sealing composition may be at least 8, such as at least 9.5, such as at least 10, such as at least 11, such as at least 12, and in some instances, may be no higher than 13. According to the present invention, the pH of the sealing composition may be 8 to 13, such as 9.5 to 12.5, such as 10-12, such as 10.5-11.5. The pH of the sealing composition may be adjusted using, for example, any acid and/or base as is necessary. According to the present invention, the pH of the sealing composition may be maintained through the inclusion of an acidic material, including water soluble and/or water dispersible acids, such as nitric acid, hydrochloric, sulfuric acid, and/or phosphoric acid. According to the present invention, the pH of the sealing composition may be maintained through the inclusion of a basic material, including, for example, water soluble and/or water dispersible bases, such as Group I carbonates, Group II carbonates, hydroxides, such as sodium hydroxide, potassium hydroxide, ammonium hydroxide, ammonia, and/or amines such as triethylamine, methylethyl amine, or mixtures thereof.

As mentioned above, the sealing composition may comprise a carrier, often an aqueous medium, so that the composition is in the form of a solution or dispersion of the lithium source in the carrier. According to the invention, the solution or dispersion may be brought into contact with the substrate by any of a variety of known techniques, such as dipping or immersion, spraying, intermittent spraying, dipping followed by spraying, spraying followed by dipping, brushing, or roll-coating. According to the invention, the solution or dispersion when applied to the metal substrate may be at a temperature ranging from 60° F. to about 150° F., such as 70° F. to 90° F. For example, the process of contacting the metal substrate with the sealing composition may be carried out at ambient or room temperature. The contact time is often from about 5 seconds to about 5 minutes, such as about 15 seconds to about 3 minutes.

According to the present invention, following the contacting with the sealing composition, the substrate optionally may be air dried at room temperature or may be dried with hot air, for example, by using an air knife, by flashing off the water by brief exposure of the substrate to a high temperature, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. According to the present invention, the substrate surface may be partially, or in some instances, completely dried prior to any subsequent contact of the substrate surface with any water, solutions, compositions, or the like. As used herein with respect to a substrate surface, “completely dry” or “completely dried” means there is no moisture on the substrate surface visible to the human eye.

Optionally, according to the present invention, following the contacting with the sealing composition, the substrate optionally may be contacted with tap water, deionized water, low conductivity water (such as less than 20 μS/cm) and/or any aqueous solution known to those of skill in the art of substrate treatment, wherein such water or aqueous solution may be at a temperature of room temperature (60° F.) to 212° F. While not wishing to be bound by theory, it is believed that such a rinse may remove materials from the substrate surface that have been removed from the deposited pretreatment layer or that are unreacted elements of the sealing composition. The substrate then optionally may be dried, for example air dried or dried with hot air as described in the preceding paragraph such that the substrate surface may be partially, or in some instances, completely dried prior to any subsequent contact of the substrate surface with any water, solutions, compositions, or the like.

According to the present invention, the deposited pretreatment layer thickness may be modified by the sealing composition. The thickness of the layer formed by the sealing composition may for instance increase the deposited pretreatment film thickness by up to 500 nm, such as 25 nm to 450 nm, such as 35 nm to 300 nm, such as 50 nm to 200 nm. The thickness of layer formed from the sealing composition can be determined using a handful of analytical techniques including, but not limited to XPS depth profiling or TEM. Alternatively, the sealing composition may only modify the chemistry or composition of the pretreatment layer without significant deposition from the sealing composition. A non-limiting example includes the removal of fluoride from a deposited Group IVB pretreatment film by substituting oxide or hydroxide, which would have minimal impact on the thickness of the deposited pretreatment film (less than 25 nm change in the pretreatment layer thickness).

An important aspect of the sealing composition of the present invention is the modification of the deposited pretreatment film layer. It has been surprisingly discovered that application of the sealing composition of the present invention to a Group IVB-pretreated substrate facilitates the removal of fluoride from the deposited pretreatment film. The fluoride content of the Group IVB-deposited film without subsequent application of the sealing composition is more than 20 wt. % fluoride, as determined by XPS depth profiling. However, it has been discovered herein that contacting the Group IVB-deposited film with the sealing composition of the present invention results in reduced fluoride in the Group IVB-deposited film as measured by XPS depth profiling, such that fluoride content in the Group IVB-deposited film is no more than 10 wt. % fluoride, such as to no more than 5% fluoride, such as to no more than 1% fluoride, such as to no more than 0.1%.

As described above, application of the sealing composition of the present invention to a substrate having thereon a Group IVB-deposited film has been surprisingly discovered to reduce the fluoride content of the deposited pretreatment layer. As used herein, the “mean F-Zr ratio” is defined as the average of the ratio of the fluoride wt. % divided by the zirconium wt. %. This is calculated over the thickness of the pretreatment layer as determined by XPS depth profiling, where the wt. % Zr falls below 10 wt. %. The mean F-Zr ratio measured on a pretreated substrate not contacted with the sealing composition is typically 1:1 to 1:3. When the pretreated substrate is contacted with the sealing composition, the mean F-Zr ratio may range from 1:5 to 1:200, such as 1:10 to 1:100, such as 1:15 to 1:80.

As used herein, the “fluoride reduction factor” refers to the mean F-Zr ratio of Group IVB pretreatment layer not contacted with the sealing composition divided by the mean F-Zr ratio of Group IVB pretreatment layer contacted with the sealing composition. According to the present invention, the fluoride reduction factor may be at least 2, such as at least 5, such as at least 10, such as at least 20, such as at least 30.

Color measurements can be determined for pretreated panels that have been electrocoated to characterize the degree of yellowing of the coated substrate. Color parameters may be determined using an Xrite Ci7800 Benchtop Sphere Spectrophotometer, 25 mm aperture available from X-Rite, Incorporated, Grandville, Mich. or such similar instruments. The Xrite Ci7800 instrument measures according to the L*a*b* color space theory. The term b* indicates a more yellow hue for positive values and a more blue hue for negative values. The term a* indicates a more green hue when negative and a more red hue when positive. The term L* indicates a black hue when L*=0 and a white hue when L*=100. Spectral reflectance is excluded (SCE mode) in these measurements.

To compare the yellowing on panels between the sanded and unsanded area of a bullseye defect, the parameter delta E can be calculated. The delta E value shows the square root of the sum of square differences of L*, a*, and b* between the bullseye (sanded) values and the non-sanded values. The smaller the value of delta E (closer to 0), the more consistent the panel coloration is when comparing the sanded and unsanded areas.

Application of the sealing composition of the present invention can reduce the yellow discoloration and improve the color consistency between the sanded and unsanded areas. On the sanded area, the b* value ranges from 0 to +15, such as +1 to +10, such as +1.6 to +5 when no sealing composition is applied. When the sealing composition of the present invention was applied, the b* value ranges from −3 to +3, such as −2 to +2, such as 0 to +1.5 for the sanded area. For the unsanded area, regardless of the contacting the pretreated substrate with the sealing composition, the b* value typically ranges from −5 to +5, such as −3 to +3, such as −2 to +2. Application of the sealing composition of the present invention to the sanded panels reduced delta E (typical range of 2 to 4), such as to a range of 0 to 2, such as 0.5 to 1.5.

Application of the sealing composition after the pretreatment composition can have little effect on the values of L* and a*. Regardless of whether the step after contacting the panel with the pretreatment composition is a deionized water rinse or the sealing composition, the L* values typically range from 0 to 60, such 25 to 55, such as 40 to 50. The a* values range from −15 to +15, such as −10 to +10, such −5 to +5.

The systems and methods of the present invention are capable of producing a substrate having a Delta E (defined below) that is reduced by at least 25%, such as at least 35%, such as at least 50%, such as at least 60%, such as at least 75%, compared to a substrate not contacted with the sealing composition of the present invention.

According to the present invention, at least a portion of the substrate surface may be cleaned and/or deoxidized prior to contacting at least a portion of the substrate surface with a sealing composition described herein or a pretreatment composition described herein, in order to remove grease, dirt, and/or other extraneous matter. At least a portion of the surface of the substrate may be cleaned by physical and/or chemical means, such as mechanically abrading the surface and/or cleaning/degreasing the surface with commercially available alkaline or acidic cleaning agents that are well known to those skilled in the art. Examples of alkaline cleaners suitable for use in the present invention include Chemkleen™ 166HP, 166M/C, 177, 490MX, 2010LP, and Surface Prep 1 (SP1), Ultrax 32, Ultrax 97, Ultrax 29, and Ultrax92D, each of which are commercially available from PPG Industries, Inc. (Cleveland, Ohio), and any of the DFM Series, RECC 1001, and 88X1002 cleaners commercially available from PRC-DeSoto International, Sylmar, Calif.), and Turco 4215-NCLT and Ridolene (commercially available from Henkel Technologies, Madison Heights, Mich.). Such cleaners are often preceded or followed by a water rinse, such as with tap water, distilled water, or combinations thereof.

As mentioned above, according to the present invention, at least a portion of the cleaned substrate surface may be deoxidized, mechanically and/or chemically. As used herein, the term “deoxidize” means removal of the oxide layer found on the surface of the substrate in order to promote uniform deposition of the pretreatment composition (described below), as well as to promote the adhesion of the pretreatment composition coating to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, citric acid, sulfuric acid, chromic acid, hydrofluoric acid, and ammonium bifluoride, or Chemdeox 395 or Ultrax (AMC) 66. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating. According to the present invention, the skilled artisan will select a temperature range of the solution or dispersion, when applied to the metal substrate, based on etch rates, for example, at a temperature ranging from 50° F. to 150° F. (10° C. to 66° C.), such as from 70° F. to 130° F. (21° C. to 54° C.), such as from 80° F. to 120° F. (27° C. to 49° C.). The contact time may be from 30 seconds to 5 minutes, such as 1 minute to 2 minutes.

Following the cleaning and/or deoxidizing step(s), the substrate optionally may be rinsed with tap water, deionized water, and/or an aqueous solution of rinsing agents in order to remove any residue. According to the present invention, the wet substrate surface may be treated with a pretreatment composition (described herein) and/or a sealing composition (described herein), or the substrate may be dried prior to treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

According to the present invention, disclosed herein is a substrate comprising, or in some instances consisting essentially of, or in some instances consisting of: a film formed from a pretreatment composition comprising, or in some cases consisting essentially of, or in some instances consisting of, a Group IVB metal cation; and a layer formed from a sealing composition comprising, or in some instances consisting essentially of, or in some instances consisting of, a Group IA metal cation.

According to the present invention, disclosed herein is a method of treating a substrate, comprising, or in some instances consisting essentially of, or in some instances consisting of, (a) contacting at least a portion of the substrate surface with a pretreatment composition comprising, or in some instances consisting essentially of, or in some instances consisting of, a Group IVB metal cation; and (b) contacting at least a portion of the substrate surface pretreatment with a sealing composition comprising, or in some instances consisting essentially of, or in some instances consisting of, a Group IA metal cation; wherein the contacting with the sealing composition occurs prior to and/or after the contacting with the pretreatment composition.

According to the present invention, after the substrate is contacted with the sealing composition, a coating composition comprising a film-forming resin may be deposited onto at least a portion of the surface of the substrate that has been contacted with the sealing composition. Any suitable technique may be used to deposit such a coating composition onto the substrate, including, for example, brushing, dipping, flow coating, spraying and the like. In some instances, however, as described in more detail below, such depositing of a coating composition may comprise an electrocoating step wherein an electrodepositable composition is deposited onto a metal substrate by electrodeposition. In certain other instances, as described in more detail below, such depositing of a coating composition comprises a powder coating step. In still other instances, the coating composition may be a liquid coating composition.

According to the present invention, the coating composition may comprise a thermosetting film-forming resin or a thermoplastic film-forming resin. As used herein, the term “film-forming resin” refers to resins that can form a self-supporting continuous film on at least a horizontal surface of a substrate upon removal of any diluents or carriers present in the composition or upon curing at ambient or elevated temperature. Conventional film-forming resins that may be used include, without limitation, those typically used in automotive OEM coating compositions, automotive refinish coating compositions, industrial coating compositions, architectural coating compositions, coil coating compositions, and aerospace coating compositions, among others. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will not melt upon the application of heat and is insoluble in solvents. As used herein, the term “thermoplastic” refers to resins that comprise polymeric components that are not joined by covalent bonds and thereby can undergo liquid flow upon heating and are soluble in solvents.

As previously indicated, according to the present invention, an electrodepositable coating composition comprising a water-dispersible, ionic salt group-containing film-forming resin that may be deposited onto the substrate by an electrocoating step wherein the electrodepositable coating composition is deposited onto the metal substrate by electrodeposition.

The ionic salt group-containing film-forming polymer may comprise a cationic salt group containing film-forming polymer for use in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups, including, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers. Examples of polymers that are suitable for use as the cationic salt group-containing film-forming polymer include, but are not limited to, alkyd polymers, acrylics, polyepoxides, polyamides, polyurethanes, polyureas, polyethers, and polyesters, among others.

The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition. As used herein, the “resin solids” include the ionic salt group-containing film-forming polymer, curing agent, and any additional water-dispersible non-pigmented component(s) present in the electrodepositable coating composition.

Alternatively, the ionic salt group containing film-forming polymer may comprise an anionic salt group containing film-forming polymer for use in an anionic electrodepositable coating composition. As used herein, the term “anionic salt group containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference.

The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

The electrodepositable coating composition may further comprise a curing agent. The curing agent may react with the reactive groups, such as active hydrogen groups, of the ionic salt group-containing film-forming polymer to effectuate cure of the coating composition to form a coating. Non-limiting examples of suitable curing agents are at least partially blocked polyisocyanates, aminoplast resins and phenoplast resins, such as phenolformaldehyde condensates including allyl ether derivatives thereof.

The curing agent may be present in the cationic electrodepositable coating composition in an amount of 10% to 60% by weight, such as 20% to 50% by weight, such as 25% to 40% by weight, based on the total weight of the resin solids of the electrodepositable coating composition. Alternatively, the curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

The electrodepositable coating composition may further comprise other optional ingredients, such as a pigment composition and, if desired, various additives such as fillers, plasticizers, anti-oxidants, biocides, UV light absorbers and stabilizers, hindered amine light stabilizers, defoamers, fungicides, dispersing aids, flow control agents, surfactants, wetting agents, or combinations thereof.

The electrodepositable coating composition may comprise water and/or one or more organic solvent(s). Water can for example be present in amounts of 40% to 90% by weight, such as 50% to 75% by weight, based on total weight of the electrodepositable coating composition. If used, the organic solvents may typically be present in an amount of less than 10% by weight, such as less than 5% by weight, based on total weight of the electrodepositable coating composition. The electrodepositable coating composition may in particular be provided in the form of an aqueous dispersion. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The cationic electrodepositable coating composition may be deposited upon an electrically conductive substrate by placing the composition in contact with an electrically conductive cathode and an electrically conductive anode, with the surface to be coated being the cathode. Alternatively, the anionic electrodepositable coating composition may be deposited upon an electrically conductive substrate by placing the composition in contact with an electrically conductive cathode and an electrically conductive anode, with the surface to be coated being the anode. An adherent film of the electrodepositable coating composition is deposited in a substantially continuous manner on the cathode or anode, respectively, when a sufficient voltage is impressed between the electrodes. The applied voltage may be varied and can be, for example, as low as one volt to as high as several thousand volts, such as between 50 and 500 volts. Current density is usually between 1.0 ampere and 15 amperes per square foot (10.8 to 161.5 amperes per square meter) and tends to decrease quickly during the electrodeposition process, indicating formation of a continuous self-insulating film.

Once the cationic or anionic electrodepositable coating composition is electrodeposited over at least a portion of the electroconductive substrate, the coated substrate is heated to a temperature and for a time sufficient to cure the electrodeposited coating on the substrate. For cationic electrodeposition, the coated substrate may be heated to a temperature ranging from 110° C. to 232.2° C., such as from 135° C. to 204.4° C., such as from 149° C. to 180° C. For anionic electrodeposition, the coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.), such as 200° F. to 210.2° F. (93° C. to 99° C.). The curing time may be dependent upon the curing temperature as well as other variables, for example, the film thickness of the electrodeposited coating, level and type of catalyst present in the composition and the like. For example, the curing time can range from 10 minutes to 60 minutes, such as 20 to 40 minutes. The thickness of the resultant cured electrodeposited coating may range from 10 to 50 microns.

Alternatively, as mentioned above, according to the present invention, after the substrate has been contacted with the pretreatment composition, and optionally with a sealer composition, a powder coating composition may then be deposited onto at least a portion of the surface of the substrate that has been contacted with the pretreatment composition, and optionally the sealer composition, as the case may be. As used herein, “powder coating composition” refers to a coating composition which is completely free of water and/or solvent. Accordingly, the powder coating composition disclosed herein is not synonymous to waterborne and/or solvent-borne coating compositions known in the art.

According to the present invention, the powder coating composition comprises (a) a film forming polymer having a reactive functional group; and (b) a curing agent that is reactive with the functional group. Examples of powder coating compositions that may be used in the present invention include the polyester-based ENVIROCRON line of powder coating compositions (commercially available from PPG Industries, Inc.) or epoxy-polyester hybrid powder coating compositions. Alternative examples of powder coating compositions that may be used in the present invention include low temperature cure thermosetting powder coating compositions comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,470,752, assigned to PPG Industries, Inc. and incorporated herein by reference); curable powder coating compositions generally comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,432,333, assigned to PPG Industries, Inc. and incorporated herein by reference); and those ccomprising a solid particulate mixture of a reactive group-containing polymer having a T_{g} of at least 30° C. (such as those described in U.S. Pat. No. 6,797,387, assigned to PPG Industries, Inc. and incorporated herein by reference).

After deposition of the powder coating composition, the coating is often heated to cure the deposited composition. The heating or curing operation is often carried out at a temperature in the range of from 150° C. to 200° C., such as from 170° C. to 190° C., for a period of time ranging from 10 to 20 minutes. According to the invention, the thickness of the resultant film is from 50 microns to 125 microns.

As mentioned above, according to the present invention, the coating composition may be a liquid coating composition. As used herein, “liquid coating composition” refers to a coating composition which contains a portion of water and/or solvent. Accordingly, the liquid coating composition disclosed herein is synonymous to waterborne and/or solventborne coating compositions known in the art.

According to the present invention, the liquid coating composition may comprise, for example, (a) a film forming polymer having a reactive functional group; and (b) a curing agent that is reactive with the functional group. In other examples, the liquid coating may contain a film forming polymer that may react with oxygen in the air or coalesce into a film with the evaporation of water and/or solvents. These film forming mechanisms may require or be accelerated by the application of heat or some type of radiation such as Ultraviolet or Infrared. Examples of liquid coating compositions that may be used in the present invention include the SPECTRACRON® line of solventbased coating compositions, the AQUACRON® line of waterbased coating compositions, and the RAYCRON® line of UV cured coatings (all commercially available from PPG Industries, Inc.).

Suitable film forming polymers that may be used in the liquid coating composition of the present invention may comprise a (poly)ester, an alkyd, a (poly)urethane, an isocyanurate, a (poly)urea, a (poly)epoxy, an anhydride, an acrylic, a (poly)ether, a (poly)sulfide, a (poly)amine, a (poly)amide, (poly)vinyl chloride, (poly)olefin, (poly)vinylidene fluoride, (poly)siloxane, or combinations thereof.

According to the present invention, the substrate that has been contacted with the pretreatment composition and optionally the sealer composition, may also be contacted with a primer composition and/or a topcoat composition. The primer coat may be, for examples, chromate-based primers and advanced performance topcoats. According to the present invention, the primer coat can be a conventional chromate based primer coat, such as those available from PPG Industries, Inc. (product code 44GN072), or a chrome-free primer such as those available from PPG (DESOPRIME CA7502, DESOPRIME CA7521, Deft 02GN083, Deft 02GN084). Alternately, the primer coat can be a chromate-free primer coat, such as the coating compositions described in U.S. patent application Ser. No. 10/758,973, titled “CORROSION RESISTANT COATINGS CONTAINING CARBON”, and U.S. patent application Ser. Nos. 10/758,972, and 10/758,972, both titled “CORROSION RESISTANT COATINGS”, all of which are incorporated herein by reference, and other chrome-free primers that are known in the art, and which can pass the military requirement of MIL-PRF-85582 Class N or MIL-PRF-23377 Class N may also be used with the current invention.

As mentioned above, the substrate of the present invention also may comprise a topcoat. As used herein, the term “topcoat” refers to a mixture of binder(s) which can be an organic or inorganic based polymer or a blend of polymers, typically at least one pigment, can optionally contain at least one solvent or mixture of solvents, and can optionally contain at least one curing agent. A topcoat is typically the coating layer in a single or multi-layer coating system whose outer surface is exposed to the atmosphere or environment, and its inner surface is in contact with another coating layer or polymeric substrate. Examples of suitable topcoats include those conforming to MIL-PRF-85285D, such as those available from PPG (Deft 03W127A and Deft 03GY292). According to the present invention, the topcoat may be an advanced performance topcoat, such as those available from PPG (Defthane® ELT.™. 99GY001 and 99W009). However, other topcoats and advanced performance topcoats can be used in the present invention as will be understood by those of skill in the art with reference to this disclosure.

According to the present invention, the metal substrate also may comprise a self-priming topcoat, or an enhanced self-priming topcoat. The term “self-priming topcoat”, also referred to as a “direct to substrate” or “direct to metal” coating, refers to a mixture of a binder(s), which can be an organic or inorganic based polymer or blend of polymers, typically at least one pigment, can optionally contain at least one solvent or mixture of solvents, and can optionally contain at least one curing agent. The term “enhanced self-priming topcoat”, also referred to as an “enhanced direct to substrate coating” refers to a mixture of functionalized fluorinated binders, such as a fluoroethylene-alkyl vinyl ether in whole or in part with other binder(s), which can be an organic or inorganic based polymer or blend of polymers, typically at least one pigment, can optionally contain at least one solvent or mixture of solvents, and can optionally contain at least one curing agent. Examples of self-priming topcoats include those that conform to TT-P-2756A. Examples of self-priming topcoats include those available from PPG (03W169 and 03GY369), and examples of enhanced self-priming topcoats include Defthane® ELT™/ESPT and product code number 97GY121, available from PPG. However, other self-priming topcoats and enhanced self-priming topcoats can be used in the coating system according to the present invention as will be understood by those of skill in the art with reference to this disclosure.

According to the present invention, the self-priming topcoat and enhanced self-priming topcoat may be applied directly to the sealed substrate. The self-priming topcoat and enhanced self-priming topcoat can optionally be applied to an organic or inorganic polymeric coating, such as a primer or paint film. The self-priming topcoat layer and enhanced self-priming topcoat is typically the coating layer in a single or multi-layer coating system where the outer surface of the coating is exposed to the atmosphere or environment, and the inner surface of the coating is typically in contact with the substrate or optional polymer coating or primer.

According to the present invention, the topcoat, self-priming topcoat, and enhanced self-priming topcoat can be applied to the sealed substrate, in either a wet or “not fully cured” condition that dries or cures over time, that is, solvent evaporates and/or there is a chemical reaction. The coatings can dry or cure either naturally or by accelerated means for example, an ultraviolet light cured system to form a film or “cured” paint. The coatings can also be applied in a semi or fully cured state, such as an adhesive.

In addition, a colorant and, if desired, various additives such as surfactants, wetting agents or catalyst can be included in the coating composition (electrodepositable, powder, or liquid). As used herein, the term “colorant” means any substance that imparts color and/or other opacity and/or other visual effect to the composition. Example colorants include pigments, dyes and tints, such as those used in the paint industry and/or listed in the Dry Color Manufacturers Association (DCMA), as well as special effect compositions.

In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the composition.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” pretreatment composition, “a” sealing composition, and “an” oxidizing agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed and/or unrecited elements, materials, ingredients and/or method steps. As used herein, “consisting of” is understood in the context of this application to exclude the presence of any unspecified element, ingredient and/or method step. As used herein, “consisting essentially of” is understood in the context of this application to include the specified elements, materials, ingredients and/or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, and/or provided on but not necessarily in contact with the surface. For example, a coating layer “formed over” a substrate does not preclude the presence of one or more other intervening coating layers of the same or different composition located between the formed coating layer and the substrate.

Unless otherwise disclosed herein, the term “substantially free,” when used with respect to the absence of a particular material, means that such material, if present at all in a composition, a bath containing the composition, and/or layers formed from and comprising the composition, only is present in a trace amount of 5 ppm or less based on a total weight of the composition, bath and/or layer(s), as the case may be. Unless otherwise disclosed herein, the term “essentially free,” when used with respect to the absence of a particular material, means that such material, if present at all in a composition, a bath containing the composition, and/or layers formed from and comprising the composition, only is present in a trace amount of 1 ppm or less based on a total weight of the composition, bath and/or layer(s), as the case may be. Unless otherwise disclosed herein, the term “completely free,” when used with respect to the absence of a particular material, means that such material, if present at all in a composition, a bath containing the composition, and/or layers formed from and comprising the composition, is absent from the composition, the bath containing the composition, and/or layers formed from and comprising same (i.e., the composition, bath containing the composition, and/or layers formed from and comprising the composition contain 0 ppm of such material). When a composition, bath containing a composition, and/or a layer(s) formed from and comprising the same is substantially free, essentially free, or completely free of a particular material, this means that such material is excluded therefrom, except that the material may be present as a result of, for example, carry-over from prior treatment baths in the processing line, municipal water sources, substrate(s), and/or dissolution of equipment.

As used herein, a “salt” refers to an ionic compound made up of metal cations and non-metallic anions and having an overall electrical charge of zero. Salts may be hydrated or anhydrous.

As used herein, “aqueous composition” refers to a solution or dispersion in a medium that comprises predominantly water. For example, the aqueous medium may comprise water in an amount of more than 50 wt. %, or more than 70 wt. % or more than 80 wt. % or more than 90 wt. % or more than 95 wt. %, based on the total weight of the medium. The aqueous medium may for example consist substantially of water.

As used herein, “pretreatment composition” refers to a composition that is capable of reacting with and chemically altering the substrate surface and binding to it to form a film that affords corrosion protection and improvements in other properties (e.g.: adhesion, color, mapping resistance).

As used herein, “pretreatment bath” refers to an aqueous bath containing the pretreatment composition and that may contain components that are byproducts of the process of contacting a substrate with the pretreatment composition.

As used herein, the term “pretreatment composition metal cation(s)” refers to metal cations of, a Group IA metal, a Group IVB metal, and/or a Group VIB metal, al.

As used herein, a “sealing composition” refers to a composition, e.g. a solution or dispersion, that affects a substrate surface or a material deposited onto a substrate surface in such a way as to alter the physical and/or chemical properties of the substrate surface (e.g., the composition affords corrosion protection).

As used herein, the term “Group IA metal” refers to an element that is in Group IA of the CAS version of the Periodic Table of the Elements as is shown, for example, in the Handbook of Chemistry and Physics, 63^{rd} edition (1983), corresponding to Group 1 in the actual IUPAC numbering. These metal ions are lithium, sodium, potassium, rubidium, and cesium.

As used herein, the term “Group IA metal compound” refers to compounds that include at least one element that is in Group IA of the CAS version of the Periodic Table of the Elements.

As used herein, the term “Group IIA metal” refers to an element that is in Group IIA of the CAS version of the Periodic Table of the Elements as is shown, for example, in the Handbook of Chemistry and Physics, 63^{rd} edition (1983), corresponding to Group 2 in the actual IUPAC numbering.

As used herein, the term “Group IIA metal compound” refers to compounds that include at least one element that is in Group IIA of the CAS version of the Periodic Table of the Elements

As used herein, the term “Group IVB metal” refers to an element that is in group IVB of the CAS version of the Periodic Table of the Elements as is shown, for example, in the Handbook of Chemistry and Physics, 63^{rd} edition (1983), corresponding to Group 4 in the actual IUPAC numbering.

As used herein, the term “Group IVB metal compound” refers to compounds that include at least one element that is in Group IVB of the CAS version of the Periodic Table of the Elements.

As used herein, the term “Group VIB metal” refers to an element that is in group VIB of the CAS version of the Periodic Table of the Elements as is shown, for example, in the Handbook of Chemistry and Physics, 63^{rd} edition (1983), corresponding to Group 6 in the actual IUPAC numbering.

As used herein, the term “Group VIB metal compound” refers to compounds that include at least one element that is in Group VIB of the CAS version of the Periodic Table of the Elements.

As used herein, the term “halogen” refers to any of the elements fluorine, chlorine, bromine, iodine, and astatine of the CAS version of the Periodic Table of the Elements, corresponding to Group VIIA of the periodic table.

As used herein, the term “halide” refers to compounds that include at least one halogen present in a reduced form (e.g.: chloride present as Cl¹⁻).

As used herein, the term “aluminum,” when used in reference to a substrate, refers to substrates made of or comprising aluminum and/or aluminum alloy, and clad aluminum substrates.

As used herein, the term “steel” when used in reference to a substrates, refers to substrate made or comprising uncoated and coated steel (alloys). Non-limiting examples of coated steels include hot-dipped galvanized, electrogalvanized, galvanneal, zinc-aluminum-magnesium (ZAM), and/or galvalume.

Unless otherwise disclosed herein, as used herein, the terms “total composition weight”, “total weight of a composition” or similar terms refer to the total weight of all ingredients being present in the respective composition including any carriers and solvents.

As used herein, unless otherwise disclosed, the term “completely free” means that a particular material is present in a composition and/or layers comprising the same in an amount of 1 ppb or less, based on a total weight of the composition or layer(s), as the case may be.

In view of the foregoing description the present invention thus relates in particular, without being limited thereto, to the following Aspects 1-28:

### ASPECTS

1. A system for treating a substrate comprising:

a pretreatment composition for treating at a least a portion of the substrate, the pretreatment composition comprising a Group IVB metal cation; and

a sealing composition for treating at least a portion of the substrate treated with the pretreatment composition, the sealing composition comprising a Group IA metal cation.

2. The system of Aspect 1, wherein the Group IVB metal cation comprises zirconium, titanium, or combinations thereof.

3. The system of any of the preceding Aspects, wherein the Group IVB metal cation is present in an amount of 50 ppm to 500 ppm based on a total weight of the pretreatment composition.

4. The system of any of the preceding Aspects, wherein the pretreatment composition further comprises an electropositive metal ion present in an amount of 5 ppm to 100 ppm based on a total weight of the pretreatment composition.

5. The system of any of the preceding Aspects, wherein the pretreatment composition further comprises a lithium cation in an amount of 5 ppm to 250 ppm based on a total weight of the pretreatment composition.

7. The system of any of the preceding Aspects, wherein the pretreatment composition further comprises a molybdenum cation in an amount of 20 ppm to 200 ppm based on a total weight of the pretreatment composition.

7. The system of any of the preceding Aspects, wherein the pretreatment composition further comprises an adhesion promoter present in an amount of 10 ppm to 10,000 ppm based on a total weight of the pretreatment composition.

8. The system of any of the preceding Aspects, wherein the pretreatment composition has a free fluoride concentration of 5 ppm to 500 ppm based on a total weight of the pretreatment composition.

9. The system of any of the preceding Aspects, wherein the Group IA metal cation is present in the sealing composition in an amount of 5 ppm to 30,000 ppm based on a total weight of the sealing composition.

10. The system of the preceding Aspects, wherein the Group IA metal cation comprises lithium, sodium, potassium, rubidium, cesium, or combinations thereof.

11. The system of any of the preceding Aspects, wherein the sealing composition further comprises a carbonate, a hydroxide, or combinations thereof.

12. The system of any of the preceding Aspects, wherein the sealing composition has a pH of 8 to 13.

13. The system of any of the preceding Aspects, wherein the sealing composition is substantially free of a Group IIA metal cation, cobalt, vanadium, or combinations thereof.

14. The system of any of the preceding Aspects, wherein the system is substantially free of phosphate, of chromium, or both.

15. A substrate obtainable by the system of any of Aspects 1-14.

16. The substrate of Aspect 15, wherein a fluoride content in a film deposited on a surface of the substrate by the pretreatment composition is no more than 10% fluoride.

17. The substrate of Aspect 15 or Aspect 16, wherein the substrate has a mean F-Zr ratio of 1:5 to 1:200.

18. The substrate of any of Aspects 15-17, wherein the substrate has a fluoride reduction factor of at least 2.

19. A method of treating a substrate comprising:

contacting at least a portion of the substrate surface with a pretreatment composition comprising a Group IVB metal cation; and

contacting at least a portion of the substrate surface with a sealing composition for treating at least a portion of the substrate treated with the pretreatment composition, comprising a Group IA metal cation; wherein the contacting with the pretreatment composition occurs prior to the contacting with the sealing composition.

20. The method of Aspect 19, wherein the substrate is rinsed with water prior to contacting with the sealing composition.

21. The method of Aspect 19 or Aspect 20, wherein the substrate is rinsed with water following the contacting with the sealing composition.

22. The method of any of Aspects 19-21, further comprising sanding at least a portion of the substrate surface; wherein the sanding occurs prior to contacting with the pretreatment composition.

23. The method of any of Aspects 19-22, wherein the substrate is rinsed with water prior to contacting with the sealing composition.

24. The method of any of Aspects 19-23, wherein the substrate is rinsed with water following the contacting with the sealing composition.

25. The method of any of Aspects 19-24, further comprising sanding at least a portion of the substrate surface; wherein the sanding occurs prior to contacting with the pretreatment composition.

26. A substrate obtainable by the method of any of Aspects 19-25.

27. The substrate of Aspect 26, wherein the substrate has a Delta E reduced by 25% compared to a substrate not contacted with the sealing composition.

28. The substrate of Aspect 26, wherein the sanded substrate surface treated according to the method has a reduction in b* value compared to a sanded substrate surface not treated with the sealing composition.

### EXAMPLES

### Preparation of Cleaners, Pretreatment Compositions, and Sealing

### Compositions Used in Examples 1-5

Preparation of Alkaline Cleaner I:

A rectangular stainless steel tank with a total volume of 37 gallons, equipped with spray nozzles, was filled with 10 gallons of deionized water. To this was added 500 mL of Chemkleen 2010LP (a phosphate-free alkaline cleaner available from PPG Industries, Inc.) and 50 mL of Chemkleen 181ALP (a phosphate-free blended surfactant additive available from PPG Industries, Inc.). A 10 mL sample of the alkaline cleaner was titrated with 0.100 N sulfuric acid to measure the free and total alkalinity. The free alkalinity was 5.2 mL as measured using a phenolphthalein end point (pink to colorless color change) and the total alkalinity was 6.4 mL as measured to a bromocresol green end point (blue to yellow color change). Alkaline cleaner I was used for examples 1, 2, 3, and 4.

Preparation of Alkaline Cleaner II:

A bath containing Standard Ultrax 14AWS Cleaner was prepared at 1.25% v/v concentration of Ultrax 14 (a mild alkaline cleaner blended with surfactants available from PPG). For spray cleaning, a 10 gallon bath was prepared using deionized water as described in the preparation of alkaline cleaner I. Alkaline cleaner II was used only for example 5.

Preparation of Deoxidizier:

A bath containing AMC66AW Deoxidizer was prepared with 2% v/v concentration of AMC66 (an acidic deoxidizer free of nitric acid available from PPG). The deoxidizer was only used in example 5.

Preparation of Pretreatment Composition:

Three different zirconium-containing pretreatment compositions (PT A-C) were prepared for testing. Each pretreatment bath was built by the addition of the metal-containing species listed in Table 2 below and described in more detail below. Zirconium was supplied to the pretreatment baths by adding fluorozirconic acid (45 wt. % in water) available from Honeywell International, Inc. (Morristown, N.J.); copper was supplied by adding a 2 wt. % Cu solution, which was prepared by dilution of a copper nitrate solution (18 wt. % Cu in water) available from Shepherd Chemical Company (Cincinnati, Ohio); molybdenum was supplied by adding sodium molybdate dihydrate available from Thermofisher Acros Organics (Geel, Belgium); and lithium was supplied by adding lithium nitrate available from Thermofisher Acros Organics.

After all of the ingredients were added to the pretreatment bath, pH was measured using a pH meter (interface, DualStar pH/ISE Dual Channel Benchtop Meter, available from ThermoFisher Scientific, Waltham, Mass., USA; pH probe, Fisher Scientific Accumet pH probe (Ag/AgCl reference electrode) by immersing the pH probe in the pretreatment solution. Free fluoride was measured using a DualStar pH/ISE Dual Channel Benchtop Meter (ThermoFisher Scientific) equipped with a fluoride selective electrode (Orion ISE Fluoride Electrode, solid state, available from ThermoFisher Scientific) by immersing the ISE in the pretreatment solution and allowing the measurement to equilibrate. Then, the pH was adjusted as needed to the specified pH range with Chemfil buffer (an alkaline buffering solution, commercially available PPG Industries, Inc. or flurozirconic acid (45 wt. % in water, available from Honeywell International, Inc., Morristown, N.J.). The free fluoride was adjusted as needed to range of 25 to 150 ppm with Chemfos AFL (a partially neutralized aqueous ammonium bifluoride solution, commercially available from PPG Industries, Inc. and prepared according to supplier instructions). The amount of copper in each Bath was measured using a DR/890 Colorimeter (available from HACH, Loveland, Colo., USA) using an indicator (CuVer1 Copper Reagent Powder Pillows, available from HACH).

Pretreatment Composition Bath A (PT-A): To a clean five-gallon plastic bucket was added 18.93 liters of deionized water. Fluorozirconic acid and the 2% copper solution were then added. The material was circulated using am immersion heater set to 80° F. The copper, pH and free fluoride were measured as described above and pH and free fluoride were adjusted with 31.0 g Chemfil buffer and 17.0 g Chemfos AFL.

Pretreatment Composition Bath B (PT-B): To a clean five-gallon plastic bucket was added 18.93 liters of deionized water. Fluorozirconic acid and the 2% copper solution was then added followed by sodium molybdate dihydrate and lithium nitrate. The copper, pH and free fluoride were measured as described above and pH and free fluoride were adjusted with 30.00 g Chemfil buffer and 5.50 g Chemfos AFL.

Pretreatment Composition Bath C (PT-C): To a clean five-gallon plastic bucket was added 18.93 liters of deionized water. Fluorozirconic acid and the 2% copper solution was then added to the solution followed by sodium molybdate dihydrate and lithium nitrate. The copper, pH and free fluoride were measured as described above and pH and free fluoride were adjusted with 30.00 g Chemfil buffer and 5.50 g Chemfos AFL.

Pretreatment Composition Bath D (PT-D): To a clean five gallon plastic bucket was added 18.93 liters of deionized water along with fluorozirconic acid and the 2% copper solution. The copper, pH and free fluoride were measured as described above and pH and free fluoride were adjusted with 32.00 g Chemfil buffer and 12.50 g Chemfos AFL.

Pretreatment Composition Bath E (PT-E): To a clean five-gallon plastic bucket was added 18.93 liters of deionized water along with fluorozirconic acid and the 2% copper nitrate solution. The copper, pH and free fluoride were measured as described above and pH and free fluoride were adjusted with 30.0 g Chemfil buffer and 13.0 g Chemfos AFL.

Pretreatment Composition Bath F (PT-F): To a clean five-gallon plastic bucket was added 18.93 liters of deionized water along with flurozirconic acid and the 2% copper nitrate solution. The copper, pH and free fluoride were measured as described above and pH and free fluoride were adjusted with 30.0 g Chemfil buffer and 13.0 g Chemfos AFL.

Pretreatment Composition Bath G (PT-G): To a clean five-gallon plastic bucket was added 18.93 liters of deionized water along with flurozirconic acid. This bath was copper-free. The pH and free fluoride were measured as described above and pH and free fluoride were adjusted with 34.0 g Chemfil buffer and 15.0 g Chemfos AFL.

Pretreatment Composition Bath H (PT-H): To a clean five-gallon plastic bucket was added 18.93 liters of deionized water along with flurozirconic acid. This bath was also copper-free. The pH and free fluoride were measured as described above and pH and free fluoride were adjusted with 34.0 g Chemfil buffer and 15.0 g Chemfos AFL. A one-gallon aliquot of this material placed into a cylindrical container and 0.44 g poly(acrylic acid) (63 wt. % Acros Organics in water, MW=2000) was added, which was used for PT-H.

TABLE 2
Pretreatment Compositions

| Pretreatment | | Zr | Mo | Li | Cu | | Free fluoride | Additive |
|---|---|---|---|---|---|---|---|---|
| Composition | Code | (ppm) | (ppm) | (ppm) | (ppm) | pH | (ppm) | (ppm) |
| Bath A | PT-A | 175 | 0 | 0 | 35 | 4.7 | 108 | |
| Bath B | PT-B | 175 | 50 | 5 | 30 | 4.8 | 62 | |
| Bath C | PT-C | 175 | 130 | 5 | 30 | 4.8 | 62 | |
| Bath D | PT-D | 200 | 0 | 0 | 35 | 4.7 | 93 | |
| Bath E | PT-E | 202 | 0 | 0 | 35 | 4.6 | 90 | |
| Bath F | PT-F | 200 | 0 | 0 | 35 | 4.6 | 90 | |
| Bath G | PT-G | 253 | 0 | 0 | 0 | 4.6 | 90 | |
| Bath H | PT-H | 253 | 0 | 0 | 0 | 4.6 | 90 | PAA (73 ppm) |

Preparation of Sealing Compositions:

Each sealing composition bath was built by the addition of the metal-containing species listed in Table 3 below and described in more detail below. Lithium was supplied to the sealing composition bath by adding lithium carbonate (available from Fisher Scientific).

Sealing Composition 1 (SC-1):

A rectangular stainless steel tank with a total volume of 37 gallons equipped with spray nozzles was filled with 37.8 liters of deionized water. To the water was added 18.90 g lithium carbonate. The solution was agitated to ensure dissolution of the materials. This sealing composition had a concentration of 500 ppm lithium carbonate. The pH of SC-1 (measured as described above) was 10.69.

Sealing Composition 2 (SC-2):

SC-2 was prepared in the same manner as SC-1, except 94.50 g of lithium carbonate was added to the deionized water. This sealing composition had a concentration of 2500 ppm lithium carbonate based on total bath composition. The pH of SC-2 (measured as described above) was 10.97.

Sealing Composition 3 (SC-3):

SC-3 was prepared in the same manner as SC-1, except that 18.93 liters of deionized water was added to the tank, followed by 47.25 g lithium carbonate. The concentration of lithium carbonate was 2496 ppm based on total bath composition and the pH (measured as described above) was 10.44.

Sealing Composition 4 (SC-4):

SC-4 was prepared by filling a plastic 64-oz. container with 1.9 kg of deionized water. To the water was added 2.37 g of lithium carbonate. The solution as agitated to ensure dissolution of the materials. This sealing composition had a pH (measured as described above) of 10.88.

Sealing Composition 5 (SC-5):

SC-5 was prepared in the same manner as SC-4, except that 1.55 g lithium hydroxide was added to the water instead of lithium carbonate. The pH of the composition (measured as described above) was 11.71.

Sealing Composition 6 (SC-6):

SC-6 was prepared in the same manner as SC-4, except that 1.19 g lithium carbonate and 0.77 g lithium hydroxide were added to the water. The pH of the composition (measured as described above) was 11.57.

Sealing Composition 7 (SC-7):

SC-7 was prepared by adding 7.50 g lithium carbonate to 3.0 liters of water. The material was agitated to ensure dissolution. The sealing composition was placed into a rectangular container without agitation when the material was applied to the pretreated panels.

Sealing Composition 8 (SC-8):

SC-8 was prepared by adding 28.55 g of lithium carbonate to 11.4 liters of deionize water in a clean 3-gallon plastic bucket. The material was agitated to ensure dissolution prior to its use.

TABLE 3
Sealing Compositions

| | | Lithium Carbonate | Lithium Hydroxide | |
|---|---|---|---|---|
| Sealing | | Concentration | Concentration | |
| Composition | Code | (ppm) | (ppm) | pH |
| 1 | SC-1 | 500 | 0 | 10.69 |
| 2 | SC-2 | 2500 | 0 | 10.97 |
| 3 | SC-3 | 2496 | 0 | 10.44 |
| 4 | SC-4 | 1247 | 0 | 10.88 |
| 5 | SC-5 | 0 | 815 | 11.71 |
| 6 | SC-6 | 626 | 405 | 11.57 |
| 7 | SC-7 | 2500 | 0 | 11.0 |
| 8 | SC-8 | 2504 | 0 | 11.0 |

In the following Examples, any bath that was heated above ambient temperature was heated with an immersion heater (Polyscience Sous Vide Professional, Model #7306AC1B5, available from Polyscience, Niles, Ill.) set to low agitation mode during immersion of panels, to circulate and heat the composition contained therein.

### Example 1

### Corrosion Performance on CRS and HDGE Panels Treated With Zirconium-Containing Pretreatment and Lithium-Containing Sealing Composition

Two different types of substrate purchased from ACT Test Panel Technologies (Hillsdale, Mich.) were evaluated. ACT cold roll steel panels (product code—28110, cut only, unpolished) were cut from 4″ by 12″ to 4″ by 6″ using a panel cutter prior to application of the alkaline cleaner. ACT hot dip galvanized exposed (HDGE) panels (product code—53170, cut only, unpolished) were cut from 4″ by 12″ to 4″ by 6″ using a panel cutter prior to application of the alkaline cleaner.

Panels were treated using either Treatment Method A or B, outlined in Tables 4 and 5 below. For panels treated according to Treatment Method A, panels were spray cleaned and degreased for 120 seconds at 10-15 psi in the alkaline cleaner (125° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot). All panels were immersed in either PT-A, PT-B, or PT-C for 120 seconds (80° F.), rinsed by a deionized water spray rinse using the using a Melnor Rear-Trigger 7-Pattern nozzle set to shower mode (75° F.) for 30 seconds, and dried with hot air (140° F.) for 120 seconds using a Hi-Velocity handheld blow-dryer made by Oster® (model number 078302-300-000) on high-setting.

For panels treated according to Treatment Method B, panels were cleaned, pretreated, and rinsed as in Method A, except that following the pretreatment and subsequent rinse, wet panels were sprayed with either one of SC-1 or SC-2 for 60 seconds (10-15 psi, 80° F.), followed by a deionized water spray rinse using the Melnor Rear-Trigger 7-Pattern nozzle set to shower mode (75° F.) for 30 seconds and then were dried with hot air (140° F.) for 120 seconds using a Hi-Velocity handheld blow-dryer made by Oster® (model number 078302-300-000) on high-setting. SC-1 and SC-2 were sprayed onto the pretreated panel using the identical tanks to those used in the cleaning stage (stainless steel, 37 gallon capacity).

TABLE 4
Treatment Method A

| | |
|---|---|
| Step 1A | Alkaline cleaner (120 seconds, 125° F., spray application) |
| Step 2A | Deionized water rinse (30 seconds, 75° F., immersion |
| | application) |
| Step 3A | Deionized water rinse (30 seconds, 75° F., spray application) |
| Step 4A | Zirconium Pretreatment (120 seconds, 80° F., immersion |
| | application) |
| Step 5A | Deionized water rinse (30 seconds, 75° F., spray application) |
| Step 6A | Hot Air Dry (120 seconds, 140° F.) |

TABLE 5
Treatment Method B

| | |
|---|---|
| Step 1B | Alkaline cleaner (120 seconds, 125° F., spray application) |
| Step 2B | Deionized water rinse (30 seconds, 75° F., immersion |
| | application) |
| Step 3B | Deionized water rinse (30 seconds, 75° F., spray application) |
| Step 4B | Zirconium Pretreatment (120 seconds, 80° F., immersion |
| | application) |
| Step 5B | Deionized water rinse (30 seconds, 75° F., spray application) |
| Step 6B | Sealer Composition (60 seconds, 80° F., spray application) |
| Step 7B | Deionized water rinse (30 seconds, 75° F., spray application) |
| Step 8B | Hot Air Dry (120 seconds, 140° F.) |

Following completion of Treatment Methods A or B, all panels were electrocoated with ED7000Z (a cathodic electrocoat with components commercially available from PPG) prepared by mixing E6433Z resin (2040 grams), E6434Z paste (358 grams), and deionized water (1604 grams). The paint was ultrafiltered removing 25% of the material, which was replenished with fresh deionized water. The rectifier (Xantrax Model XFR600-2, Elkhart, Ind., or Sorensen XG 300-5.6, Ameteck, Berwyn, Pa.) was DC power supplied. The electrocoat application conditions were voltage set point of 180V-200V, a ramp time of 30s, and a current density of 1.6 mA/cm². The electrocoat was maintained at 90° F. The film thickness was time-controlled to deposit a target film thickness of 0.8±0.2 mils for both CRS and HDGE substrates. The DFT was controlled by changing the amount of charge (coulombs) that passed through the panels. Following deposition of the electrocoat, panels were baked in an oven (Despatch Model LFD-1-42) at 177° C. for 25 minutes.

Electrocoated panels were scribed with a 10.2 cm vertical line in the middle of the panel down to the metal substrate. Scribed panels were exposed to GM cyclic corrosion test GMW14872 for 40 days for CRS and 80 days for HDGE. Panels were subjected to media blasting (MB-2, an irregular granular plastic particle with a Moh's hardness of 3.5 and size range of 0.58 mm-0.84 mm available from Maxi-Blast, Inc., South Bend, Ind.) using an In Line Conveyor System IL-885 Sandblaster (incoming air pressure of 85 psi, Empire Abrasivr Equipment Company, model information: IL885-M9655) after corrosion testing to remove loosely adhered paint and corrosion products. Panels for each condition were run in triplicate. The average scribe creep of three panels is shown in Tables 6 and 7 below. Scribe creep refers to the area of paint loss around the scribe either through corrosion or disbondment (e.g.: affected paint to affected paint).

TABLE 6
CRS Corrosion Results after 40 Cycles
in GMW14872 Cyclic Corrosion Testing

| | Treatment | Pretreatment | Sealing | Average Scribe |
|---|---|---|---|---|
| Condition | Protocol | Bath | Composition | Creep (mm) |
| 1A | Method A | PT-A | Not applicable | 5.4 |
| 1B | Method B | PT-A | SC1 | 4.2 |
| 1C | Method B | PT-A | SC2 | 4.5 |
| 1D | Method A | PT-B | Not applicable | 4.8 |
| 1E | Method B | PT-B | SC1 | 3.6 |
| 1F | Method B | PT-B | SC2 | 4.3 |
| 1G | Method A | PT-C | Not applicable | 5.2 |
| 1H | Method B | PT-C | SC1 | 4.2 |
| 1I | Method B | PT-C | SC2 | 3.9 |

TABLE 7
HDGE Corrosion Results after 80 Cycles
in GMW14872 Cyclic Corrosion Testing

| | Treatment | Pretreatment | Sealing | Average Scribe |
|---|---|---|---|---|
| Condition | Protocol | Bath | Composition | Creep (mm) |
| 1A | Method A | Bath A | Not applicable | 3.1 |
| 1B | Method B | Bath A | SC1 | 1.7 |
| 1C | Method B | Bath A | SC2 | 1.5 |
| 1D | Method A | Bath B | Not applicable | 2.0 |
| 1E | Method B | Bath B | SC1 | 2.5 |
| 1F | Method B | Bath B | SC2 | 2.6 |
| 1G | Method A | Bath C | Not applicable | 3.9 |
| 1H | Method B | Bath C | SC1 | 4.2 |
| 1I | Method B | Bath C | SC2 | 1.7 |

These data demonstrate that application of a lithium carbonate sealing composition following pretreatment with a zirconium-containing pretreatment composition sealer improves corrosion resistance on CRS regardless of whether the pretreatment composition includes lithium or molybdenum. On HDG, corrosion resistance was improved when panels were treated with the sealing composition having the higher concentration (2500 ppm) of lithium carbonate when the pretreatment composition was free of molybdenum or when the pretreatment composition had the higher concentration (130 ppm) of molybdenum.

### Example 2

### Adhesion on HDG Panels Treated With Zirconium-Containing Pretreatment and Lithium-Containing Sealing Composition

Substrate was obtained from Chemetall. Hot dip galvanized steel panels (Gardobond MBZ1/EA, 105 mm×190 mm×0.75 mm, oiled, without treatment) were cut in half prior to application of the alkaline cleaner yielding 5.25 cm×9.5 cm panels.

Panels were treated using either Treatment Method C, D, or E, outlined in Tables 8, 9 and 10 below. For panels treated according to Treatment Method C, panels were spray cleaned as described above and degreased for 120 seconds at 10-15 psi in the alkaline cleaner described above (125° F.) and rinsed with deionized water by immersing in a deionized water bath (75° F.) for 30 seconds followed by a deionized water spray rinse using the nozzle described above (75° F.) for 30 seconds. All panels were immersed in Pretreatment D for 120 seconds (80° F.), rinsed by a deionized water spray rinse as described above (75° F.) for 30 seconds, and dried with hot air (140° F.) for 120 seconds using a Hi-Velocity handheld blow-dryer made by Oster® (model number 078302-300-000) on high-setting.

For panels treated according to Treatment Method D, panels were cleaned, pretreated, and rinsed as in Method C, except that following the pretreatment and subsequent rinse, wet panels were immediately immersed in SC-3 for 60 seconds (80° F.), followed by a deionized water spray rinse as described above (75° F.) for 30 seconds and then were dried with hot air (140° F.) for 120 seconds using a Hi-Velocity handheld blow-dryer made by Oster® (model number 078302-300-000) on high-setting.

For panels treated according to Treatment Method E, panels were cleaned, pretreated, rinsed, and sealed as in Method D, except that SC-3 was at a temperature of 120° F. for 60 seconds, followed by a deionized water spray rinse as described above (75° F.) for 30 seconds and then were dried with hot air (140° F.) for 120 seconds using a Hi-Velocity handheld blow-dryer made by Oster® (model number 078302-300-000) on high-setting.

TABLE 8
Treatment Method C

| | |
|---|---|
| Step 1C | Alkaline cleaner (120 seconds, 125° F., spray application) |
| Step 2C | Deionized water rinse (30 seconds, 75° F., immersion |
| | application) |
| Step 3C | Deionized water rinse (30 seconds, 75° F., spray application) |
| Step 4C | Zirconium Pretreatment (120 seconds, 80° F., immersion |
| | application) |
| Step 5C | Deionized water rinse (30 seconds, 75° F., spray application) |
| Step 6C | Hot Air Dry (120 seconds, 140° F.) |

TABLE 9
Treatment Method D

| | |
|---|---|
| Step 1D | Alkaline cleaner (120 seconds, 125° F., spray application) |
| Step 2D | Deionized water rinse (30 seconds, 75° F., immersion |
| | application) |
| Step 3D | Deionized water rinse (30 seconds, 75° F., spray application) |
| Step 4D | Zirconium Pretreatment (120 seconds, 80° F., immersion |
| | application) |
| Step 5D | Deionized water rinse (30 seconds, 75° F., spray application) |
| Step 6D | SC-3 (60 seconds, 80° F., immersion application) |
| Step 7D | Deionized water rinse (10 seconds, 75° F., spray application) |
| Step 8D | Hot Air Dry (120 seconds, 140° F.) |

TABLE 10
Treatment Method E

| | |
|---|---|
| Step 1E | Alkaline cleaner (120 seconds, 125° F., spray application) |
| Step 2E | Deionized water rinse (30 seconds, 75° F., immersion |
| | application) |
| Step 3E | Deionized water rinse (30 seconds, 75° F., spray application) |
| Step 4E | Zirconium Pretreatment (120 seconds, 80° F., immersion |
| | application) |
| Step 5E | Deionized water rinse (30 seconds, 75° F., spray application) |
| Step 6E | SC-3 (60 seconds, 120° F., immersion application) |
| Step 7E | Deionized water rinse (10 seconds, 75° F., spray application) |
| Step 8E | Hot Air Dry (120 seconds, 140° F.) |

Following completion of Treatment Methods C, D, or E, all panels were electrocoated with ED6280Z (a cathodic electrocoat with components commercially available from PPG) prepared by mixing E6419Z resin (9895 grams), E6420Z paste (987 grams), and deionized water (6315 grams). The paint was ultrafiltered as described in Example 1. The dry film thickness was time-controlled to deposit a target film thickness of 0.8±0.2 mils.

White topcoat was then applied to the electrocoated panels. The topcoat is available from PPG Industries, Inc. as a three part system composed of a primer, basecoat, and clearcoat. The product codes, dry film thickness ranges, and bake conditions are shown in Table 11 below.

TABLE 11
Three Part Topcoat System.

| | Product | Dry Film Thickness | Bake |
|---|---|---|---|
| Layer | Code | Range (mils) | (Temperature/Time) |
| Primer | SCP6534 | 0.95 ± 0.15 | 141° C./30 minutes |
| Basecoat | UDCT6466 | 1.1 ± 0.1 | None |
| Clearcoat | TMAC9000 | 1.9 ± 0.1 | 82° C./7 minutes then |
| | | | 141° C./30 minutes |

The paint adhesion for panels treated according to each Treatment Method C, D, and E was then tested under dry (unexposed) and wet (exposed) conditions. Two panels were tested and the average adhesion value is shown in Table 12 for unexposed and exposed conditions. For the dry adhesion test, a razor blade was used to scribe eleven lines parallel and perpendicular to the length of the one of the electrocoated panels. The resultant grid area of the scribed lines was 0.5″×0.5″ to 0.75″ to 0.75″ square. Dry adhesion was assessed by using 3M's Fiber 898 tape, which was firmly adhered over the scribed grid area by finger rubbing it multiple times prior to pulling it off. The crosshatch area was evaluated for paint loss on a scale from 0 to 10, with 0 being total paint loss and 10 being absolutely no paint loss (see below). An adhesion value of 8 is considered acceptable in the automotive industry. For the exposed adhesion test, following topcoat application, the panel was immersed in deionized water (40° C.) for ten days, at which time the panels were removed, wiped with a towel to dry and allowed to sit at ambient temperature for one hour prior to crosshatching and tape-pulling to evaluate paint adhesion as described above.

TABLE 12
Adhesion Results

| | | Pre- | | Dry Cross | Wet Cross |
|---|---|---|---|---|---|
| Condi- | Treatment | treatment | Sealing | Hatch | Hatch |
| tion | Protocol | Bath | Composition | Rating* | Rating* |
| Control | Method C | Bath D | Not applicable | 9 | 6 |
| 2A | Method D | Bath D | SC-3 (80° F.) | 8.5 | 8 |
| 2B | Method E | Bath D | SC-3 (120° F.) | 9.5 | 8.5 |

*Average of two separate panels

The rating scale used in Example 2 was as follows in Table 13 and defined by a high rating indicative of greater adhesion between the substrate surface, pretreatment film, and the organic coating layer (e.g.: electrocoat, topcoat, or powdercoat).

TABLE 13
Crosshatch Rating Description

| Rating | Percent Paint Loss |
|---|---|
| 10 | Perfect Paint Adhesion (0% Paint Loss) |
| 9 | 5% Paint Loss |
| 8 | 10% Paint Loss |
| 7 | 25% Paint Loss |
| 6 | 50% Paint Loss |
| 5 | 60% Paint Loss |
| 4 | 70% Paint Loss |
| 3 | 80% Paint Loss |
| 2 | 90% Paint Loss |
| 1 | Greater than 95% Paint Loss |
| 0 | 100% Paint Loss |

Exposed cross-hatch testing is an important evaluation because poor cross-hatch adhesion indicates there is a weakness within automotive coating stack. This is especially important on HDG substrates where paint adhesion is an identified challenge. The adhesion problem is further exacerbated because the exterior skin of automotive construction is often HDG because it provides excellent corrosion resistance. These data demonstrate that application of the lithium sealer improves dry cross-hatch, but most significantly allows for passing performance in exposed cross-hatch testing.

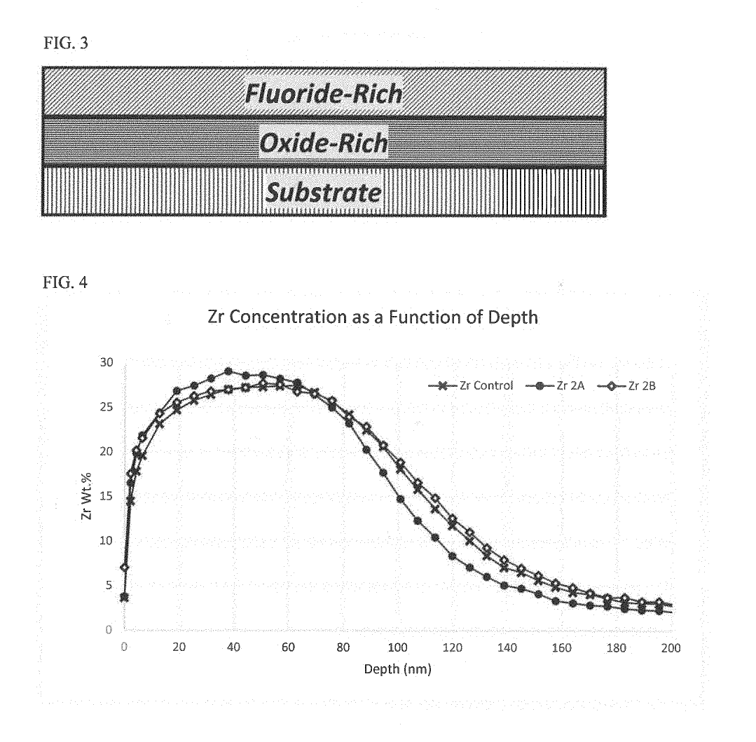

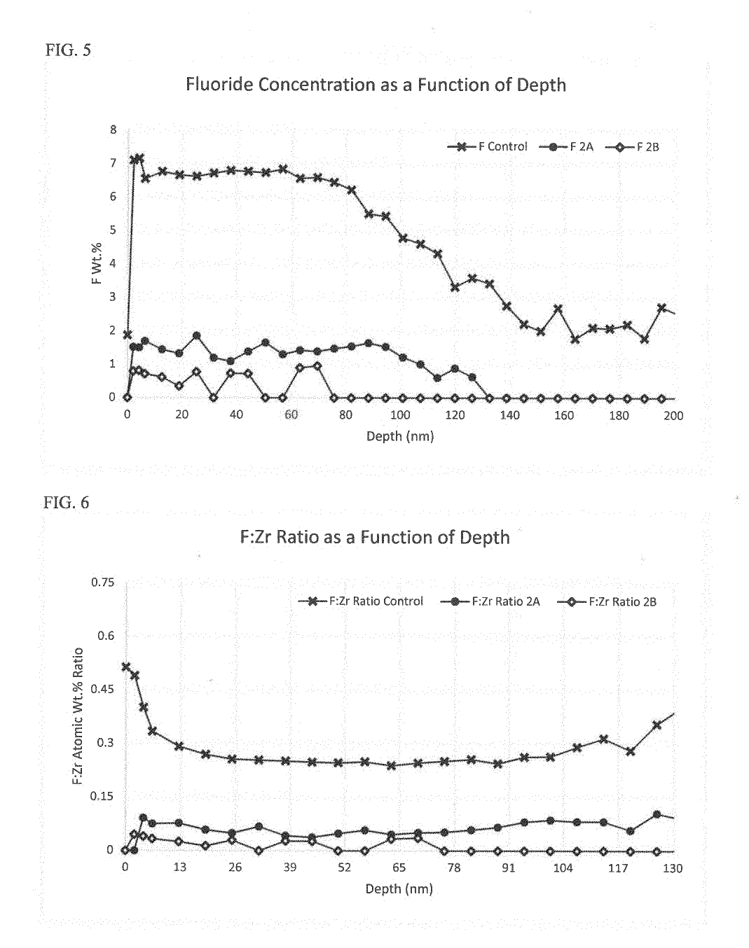

The thickness of the pretreatment, in nanometers, as measured by XPS depth profiling is defined by the Zr wt. % falling below the 10% threshold. The pretreatment film thickness is reported in the Table 14. The pretreatment film treated with SC-3 was characterized by comparing the Zr Wt. % determined by XPS as function of depth, as shown in FIG. 4, to the F Wt. % determined by XPS as a function of depth, as shown in FIG. 5. To compare the impact of the sealing composition on the fluoride level of the deposited pretreatment layer, the “Mean F-Zr Ratio” and the “fluoride reduction factor” were determined for Example 2. These data are reported in Table 14. FIG. 6 was used to calculate the “Mean F-Zr Ratio.”

TABLE 14
Pretreatment Film Parameters Measured by XPS Depth Profiling

| | | | | Pretreatment | Mean | Fluoride |
|---|---|---|---|---|---|---|
| | Treatment | Pretreatment | Sealing | Film Thickness | F—Zr | Reduction |
| Condition | Protocol | Bath | Composition | (nm) | Ratio | Factor |
| Control | Method C | PT-D | Not applicable | 126 | 0.301 | — |
| 2A | Method D | PT-D | SC-3 (80° F.) | 115 | 0.064 | 4.7 |
| 2B | Method E | PT-D | SC-3 (120° F.) | 130 | 0.013 | 23.2 |

The data of Example 2 show that treatment of HDG panels with a sealing composition containing lithium carbonate improves wet adhesion compared to panels that are not treated with the sealing composition. Application of the sealing composition at higher temperatures provides an extra benefit in both dry and wet adhesion. The Zr depth profiles shown in FIG. 4 demonstrate that the alkaline sealer composition does not change the thickness of the deposited pretreatment film (as determined by the 10 wt. % Zr threshold). The fluoride depth profiles shown in FIG. 5 demonstrate that the alkaline sealer composition significantly reduces the concentration of fluoride at the PT/air interface (depth=0 nm) and throughout the entirety of the deposited pretreatment film. Additionally, FIG. 5 demonstrates that increased sealer temperature will increase the efficiency of the fluoride reduction. While not wishing to be bound by theory, it is hypothesized that fluoride reduction in the pretreatment film occurs when panels are treated with the sealing composition. Fluoride is known to accelerate corrosion and under acidic conditions can dissolve Zr-based pretreatments by chelating with the metal center. Additionally, the pretreatment layer treated with the sealing composition has a higher concentration of hydroxide/oxide which can improve covalent bonding with the deposited electrocoat film thereby increasing adhesion. Therefore, it is hypothesized that removing fluoride from the pretreatment/electrocoat interface resulted in better adhesion.

### Example 3

### Adhesion on HDG Panels Treated With Zirconium-Containing Pretreatment and Lithium-Containing Sealing Composition

In order to evaluate the effect of the anion of the sealing composition on the deposited pretreatment composition, sealing compositions comprised of LiOH, Li₂CO₃, or a 1:1 mixture of LiOH and Li₂CO₃ were applied to panels following treatment with Pretreatment Composition E. The deposited pretreatment film was characterized by XPS depth profiling.

HDG panels were purchased from Chemetall with the same specifications as in Example 2.

Panels were treated according to Treatment Method F, as in Table 15 below. Panels were spray cleaned and degreased for 120 seconds at 10-15 psi in the alkaline cleaner as described above (120° F.) and rinsed with deionized water by immersing in a deionized water bath (75° F.) for 30 seconds followed by a deionized water spray rinse as described above (75° F.) for 30 seconds. All panels were immersed in Pretreatment E for 120 seconds (80° F.), rinsed by a deionized water spray rinse as described above (75° F.) for 30 seconds, and dried with hot air (140° F.) for 120 seconds using a Hi-Velocity handheld blow-dryer made by Oster® (model number 078302-300-000) on high-setting.

For panels treated according to Treatment Method G (see Table 16) panels were cleaned, pretreated, and rinsed as in Method F, except that following the pretreatment and subsequent rinse, wet panels were immediately immersed into either SC-4, SC-5, or SC-6 for 60 seconds (75° F.), followed by a deionized water spray rinse as described above (75° F.) for 10 seconds and then were dried with hot air (140° F.) for 120 seconds using a Hi-Velocity handheld blow-dryer made by Oster® (model number 078302-300-000) on high-setting.

TABLE 15
Treatment Method F

| | |
|---|---|
| Step 1 F | Alkaline cleaner (120 seconds, 120° F., spray application) |
| Step 2 F | Deionized water rinse (30 seconds, 75° F., immersion |
| | application) |
| Step 3 F | Deionized water rinse (30 seconds, 75° F., spray application) |
| Step 4 F | Zirconium Pretreatment (120 seconds, 80° F., immersion |
| | application) |
| Step 5 F | Deionized water rinse (30 seconds, 75° F., spray application) |
| Step 6 F | Hot Air Dry (120 seconds, 140° F.) |

TABLE 16
Treatment Method G

| | |
|---|---|
| Step 1G | Alkaline cleaner (120 seconds, 120° F., spray application) |
| Step 2G | Deionized water rinse (30 seconds, 75° F., immersion |
| | application) |
| Step 3G | Deionized water rinse (30 seconds, 75° F., spray application) |
| Step 4G | Zirconium Pretreatment (120 seconds, 80° F., immersion |
| | application) |
| Step 5G | Deionized water rinse (30 seconds, 75° F., spray application) |
| Step 6G | Sealing Composition (60 seconds, 75° F., immersion |
| | application) |
| Step 7G | Deionized water rinse (10 seconds, 75° F., spray application) |
| Step 8G | Hot Air Dry (120 seconds, 140° F.) |

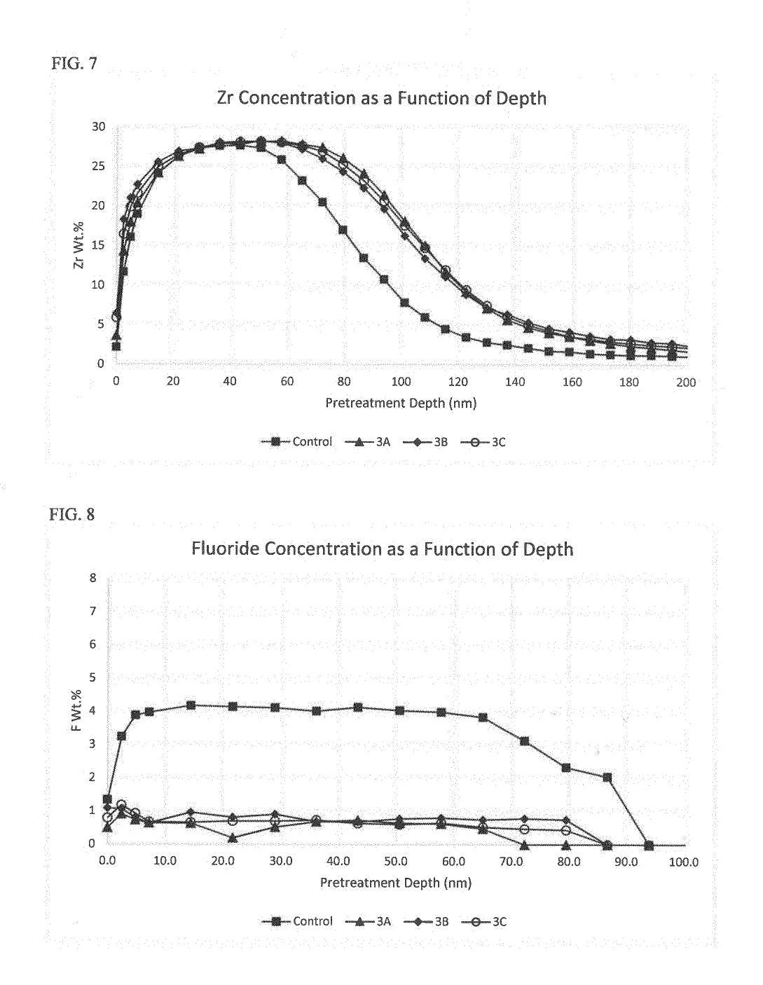

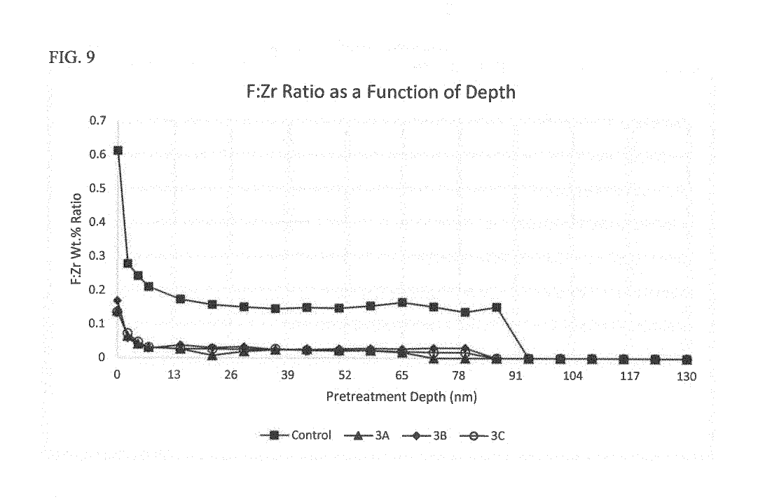

The thickness of the pretreatment, in nanometers, as measured by XPS depth profiling is defined by the Zr wt. % falling below the 10% threshold. The pretreatment film thickness is reported in the Table 17. The pretreatment film treated with SC-4, SC-5, and SC-6 was characterized by comparing the Zr Wt. % determined by XPS depth profiling as function of depth, as shown in FIG. 7, to the F Wt. % determined by XPS depth profiling as a function of depth, as shown in FIG. 8. To compare the impact of varying the lithium source in the sealing composition on the fluoride level of the deposited pretreatment layer, the “Mean F-Zr Ratio” and the “fluoride reduction factor” were determined for Example 3. These data are reported in Table 17. FIG. 9 was used to calculate the “Mean F-Zr Ratio.”

TABLE 17
Pretreatment Film Parameters Measured by XPS Depth Profiling

| | | | | | Ratio of | Reduction in |
|---|---|---|---|---|---|---|
| | | | | | Fluoride | Fluoride |
| | | | | Pre-treatment | Wt. % to | Content of |
| | Treatment | Pre-treatment | Sealing | Film Thickness | Zirconium | Pretreatment |
| Condition | Protocol | Bath | Comp. | (nm) | Wt. % | Film |
| Control | Method F | PT-E | Deonized | 95 | 0.179 | — |
| | | | Water Rinse | | | |
| 3A | Method G | PT-E | SC-4 | 119 | 0.016 | 11.2 |
| 3B) | Method G | PT-E | SC-5 | 120 | 0.022 | 8.1 |
| 3C | Method G | PT-E | SC-6 | 120 | 0.027 | 6.6 |

The data of Example 3 show that treatment of HDG panels with a sealing composition containing lithium carbonate, lithium hydroxide, or a mixture of both salts remove fluoride present in the deposited pretreatment film. The Zr depth profiles shown in FIG. 7 demonstrate that the alkaline sealer composition does not significantly change the thickness of the deposited pretreatment film (as determined by the 10 wt. % Zr threshold). The fluoride depth profiles shown in FIG. 8 demonstrate that the alkaline sealer composition significantly reduces the concentration of fluoride at the PT/air interface (depth=0 nm) and throughout the entirety of the deposited pretreatment film. Additionally, all three lithium-based sealer compositions reduced the fluoride content of the deposited pretreatment film. While not wishing to be bound by theory, it is hypothesized that fluoride reduction in the pretreatment film occurs when panels are treated with the sealing composition, regardless of whether it is lithium hydroxide, lithium carbonate, or a mixture of both. The mechanism of fluoride removal can be attributed to the alkaline pH which indicates an excess of hydroxide anions. The modified composition of the deposited pretreatment film resulting from contacting with any lithium-containing sealing composition was similar.

### Example 4

### Effect of Lithium-Containing Sealing Composition on Yellowing of Electrocoat

Copper may be added to pretreatment compositions to improve adhesion and corrosion performance especially on steel substrates. When higher bath concentrations of copper are utilized in zirconium-containing pretreatment compositions, the cured electrocoat film tends to be yellow. This discoloration is considered negative for the appearance by the customer.

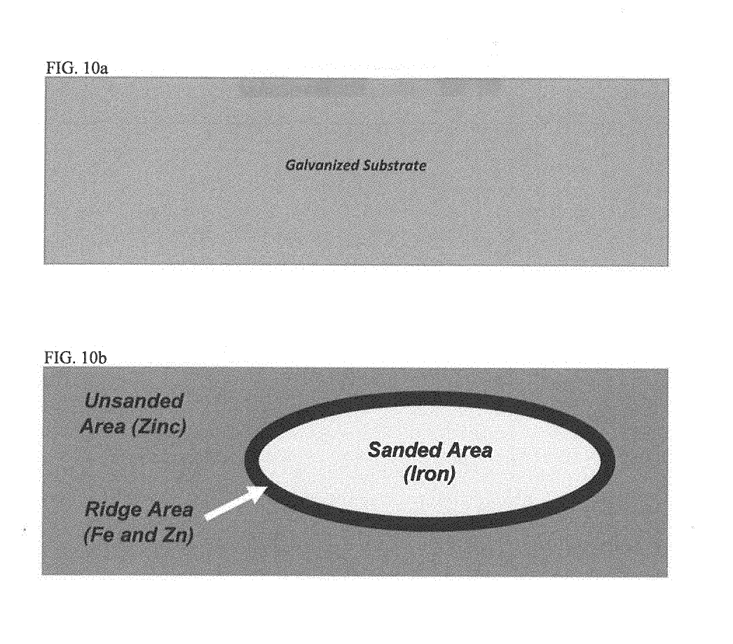

Additionally, substrate that is received into manufacturing plants may have apparent damage present on a surface of the substrate. To mitigate the influence of substrate damage on the overall appearance of the substrate, sanding techniques may be employed to remove the visible defect, which exposes the underlying ferrous layer. In the automotive industry, such a sanded panel is called a bullseye defect. An example of a bullseye defect is depicted in FIG. 10b. The color and appearance of the bullseye can be impacted by the pretreatment and electrocoat.

Another aspect of sanding is the formation of a transition area that is comprised of a mixture of both iron and zinc, depicted in FIG. 10b. In the case of hot dip galvanized substrate, aluminum will also be present in the transition area. This area can present itself as a defect after the electrocoat has been cured. This visible defect results from the difference in dry film thickness that between the exposed iron and the zinc area.

Rates of deposition of pretreatment are influenced by the metal reduction potential. Hence, the rate of deposition on the unsanded portion (Zn) and the sanded portion (Fe) of a bullseye panel can change the pretreatment composition and thickness. Steel substrates will deposit more copper relative to zirconium compared to zinc substrates. As previously stated, high levels of deposited copper will tend to increase the yellowing. As a result, a basic sealer was applied in this Example to bullseye panels to equalize the surface composition of the unsanded and sanded area.

HDGE Panels measuring 4″×12″ were purchased from ACT. An orbital sander was used to remove zinc in an oval shape and expose the underlying iron substrate on an as received panel. An unsanded galvanized panel is shown in FIG. 10a and a panel having an oval shape of the zinc removed is shown in FIG. 10b. Sandpaper 120-grit was obtained from 3M (3M Stikit Paper Disc Roll 236U 6″×NH Aluminum Oxide P120) and a 6-inches sander was obtained from ADT (ADT Tools 2088 6″ Random Orbital Palm Sander). The incoming air pressure for the sander was set to 60 PSI.

Panels were treated according to Treatment Method H, as in Table 18 below. Panels were spray cleaned and degreased for 120 seconds at 10-15 psi in the alkaline cleaner as described above (120° F.) and rinsed with deionized water by immersing in a deionized water bath (75° F.) for 30 seconds followed by a deionized water spray rinse as described above (75° F.) for 30 seconds. All panels were immersed in PT-F for 120 seconds (80° F.), rinsed by a deionized water spray rinse as described above (75° F.) for 30 seconds, and dried with hot air (140° F.) for 120 seconds using a Hi-Velocity handheld blow-dryer made by Oster® (model number 078302-300-000) on high-setting.

For panels treated according to Treatment Method I (see Table 19) panels were cleaned, pretreated, and rinsed as in Method H, except that following the pretreatment and subsequent rinse, wet panels were immediately immersed in SC-7 for 120 seconds (75° F.), followed by a deionized water spray rinse as described above (75° F.) for 10 seconds and then were dried with hot air (140° F.) for 120 seconds using a Hi-Velocity handheld blow-dryer made by Oster® (model number 078302-300-000) on high-setting.

TABLE 18
Treatment Method H.

| | |
|---|---|
| Step 1H | Alkaline cleaner (120 seconds, 120° F., spray application) |
| Step 2H | Deionized water rinse (30 seconds, 75° F., immersion |
| | application) |
| Step 3H | Deionized water rinse (30 seconds, 75° F., spray application) |
| Step 4H | Zirconium Pretreatment (120 seconds, 80° F., immersion |
| | application) |
| Step 5H | Deionized water rinse (30 seconds, 75° F., spray application) |
| Step 6H | Hot Air Dry (120 seconds, 140° F.) |

TABLE 19
Treatment Method I

| | |
|---|---|
| Step 1I | Alkaline cleaner (120 seconds, 120° F., spray application) |
| Step 2I | Deionized water rinse (30 seconds, 75° F., immersion |
| | application) |
| Step 3I | Deionized water rinse (30 seconds, 75° F., spray application) |
| Step 4I | Zirconium Pretreatment (120 seconds, 80° F., immersion |
| | application) |
| Step 5I | Deionized water rinse (30 seconds, 75° F., spray application) |
| Step 6I | Sealing Composition (120 seconds, 75° F., immersion |
| | application, no agitation) |
| Step 7I | Deionized water rinse (10 seconds, 75° F., spray application) |
| Step 8I | Hot Air Dry (120 seconds, 140° F.) |

Panels were then electrocoated with a ED7000Z as described in Example 1 to a target DFT on the unsanded zinc portion of 0.6 mils. Panels were then analyzed by colorimetry using an Xrite Ci7800 Benchtop Sphere Spectrophotometer, 25 mm aperture to compare the degree of electrocoat yellowing.

Data are shown in Table 20 below. The delta E value shows the square root of the sum of square differences of L*, a*, and b* between the bullseye (sanded) values and the non-sanded values. The closer to zero these values are, the closer the match of the two regions. The term b* indicates a more yellow hue for positive values and a more blue hue for negative values. The term a* indicates a more green hue when negative and a more red hue when positive. The term L* indicates a black hue when L*=0 and a white hue when L*=100.

TABLE 20
Colorimetry

| | L* | a* | b* | Delta E |
|---|---|---|---|---|
| Control—Sanded | 46.67 | −2.41 | 1.67 | 3.11 |
| Control—Unsanded | 47.92 | −1.96 | −1.14 | |
| Li Sealer—Sanded | 47.01 | −2.37 | 1.37 | 1.18 |
| Li Sealer—Unsanded | 48.10 | −2.18 | 0.97 | |

The data in Table 20 demonstrate that treatment with the lithium carbonate sealing composition following zirconium pretreatment reduced the yellowing of the bullseye compared to a deionized water rinse as evidenced by the reduction in b*. Additionally, the color consistency of the sanded and unsanded panel is closer when a sealing composition is applied as supported by the decrease in delta E (closer to zero).

### Example 5

### Zirconium Pretreatment and Basic Sealing Composition on AA6061 Aluminum Alloy

High levels of copper deposited by a zirconium-based pretreatment onto aluminum substrate is known to have a negative impact on corrosion despite the positive effect on adhesion that copper provides for zirconium-based pretreatments. The data of Example 5 demonstrates that the addition of polymers to a pretreatment composition containing zirconium only and improves adhesion performance without the negatively impacting corrosion as high copper levels can.

Panels were treated according to Treatment Method J, as in Table 21 below. Panels were subjected to alkaline cleaning and a deoxidation step to remove oils and intermetallics from the substrate surface. The alkaline cleaner used was Ultrax 14AWS. Panels were immersed in either PT-G or PT-H for 120 seconds (80° F.), rinsed by a deionized water spray rinse as described above (75° F.) for 15 seconds, and dried with hot air (140° F.) for 120 seconds using a Hi-Velocity handheld blow-dryer made by Oster® (model number 078302-300-000) on high-setting.

For panels treated according to Treatment Method K (see Table 22) panels were cleaned, pretreated, and rinsed as in Method J, except that following the pretreatment (either PT-G or PT-H) and subsequent rinse, wet panels were immediately immersed in SC-8 for 120 seconds (75° F.), followed by a deionized water spray rinse as described above (75° F.) for 10 seconds and then were dried with hot air (140° F.) for 120 seconds using a Hi-Velocity handheld blow-dryer made by Oster® (model number 078302-300-000) on high-setting.

TABLE 21
Treatment Method J

| | |
|---|---|
| Step 1J | Ultrax 14AWS (120 seconds, 49° C., spray application) |
| Step 2J | Deionized water rinse (15 seconds, 75° F., immersion |
| | application) |
| Step 3J | Deionized water rinse (15 seconds, 75° F., spray application) |
| Step 4J | AMC66AW (60 seconds, 49° C., immersion application) |
| Step 5J | Deionized water rinse (15 seconds, 75° F., spray application) |
| Step 6J | Zirconium Pretreatment (120 seconds, 80° F., immersion |
| | application) |
| Step 7J | Deionized water rinse (30 seconds, 75° F., spray application) |
| Step 8J | Hot Air Dry (120 seconds, 140° F.) |

TABLE 22
Treatment Method K

| | |
|---|---|
| Step 1K | Ultrax 14AWS (120 seconds, 49° C., spray application) |
| Step 2K | Deionized water rinse (15 seconds, 75° F., immersion |
| | application) |
| Step 3K | Deionized water rinse (15 seconds, 75° F., spray |
| | application) |
| Step 4K | AMC66AW (60 seconds, 49° C., immersion application) |
| Step 5K | Deionized water rinse (15 seconds, 75° F., spray |
| | application) |
| Step 6K | Zirconium Pretreatment (120 seconds, 80° F., immersion |
| | application) |
| Step 7K | Deionized water rinse (15 seconds, 75° F., spray |
| | application) |
| Step 8K | Lithium Sealer (120 seconds, 75° F., immersion |
| | application, no agitation) |
| Step 9K | Deionized water rinse (30 seconds, 75° F., spray |
| | application) |
| Step 10K | Hot Air Dry (120 seconds, 140° F.) |

TABLE 23
Adhesion Results on AA6061 Coated with Powder Coat

| | Treatment | PreTreatment | Sealing | Wet Adhesion |
|---|---|---|---|---|
| Condition | Protocol | Bath | Composition | Rating |
| Control | Method J | PT-G | — | 8.5 |
| 5A | Method J | PT-H | — | 8.0 |
| 5B | Method K | PT-G | SC-8 | 8.0 |
| 5C | Method K | PT-H | SC-8 | 10.0 |

Aluminum alloy 6061 panels (ACT Test Panels, LLC) were cut in half to make panel size 4″×6″. After the pretreatment was applied, panels were dried. After drying, the panels were powder coated with Enviracryl® PCC10103, available from PPG. The coating was applied electrostatically to target a 2.75 mil thickness. After the coating was applied, the panels were baked in an oven (Despatch Model LFD-1-42) at 177° C. for 17 minutes. The coating thickness was measured using a film thickness gauge (Fischer Technology Inc. Model FMP40C).

Panels were subjected to crosshatch adhesion testing after 1 day soaking in a water bath heated to 60° C. Panels were allowed to recover for 20 minutes in ambient conditions prior to adhesion testing. With a razor blade and a Gardco Temper II Gauge tool, eleven cuts spaced 1.5 mm apart were made perpendicular to another eleven cuts spaced 1.5 mm apart. 3M's Fiber 898 tape was adhered to the area, rubbed using a finger, and quickly pulled away. Paint adhesion was rated on a scale of 1 (no remaining paint adhesion) to 10 (perfect adhesion) as described in Example 2. The reported rating was an averageof two measurements. The results are shown in Table 23 above.

When the adhesion promoting copper was removed from the pretreatment composition and replaced with a polymer (e.g.; acrylic acid), no improvement in adhesion was observed. When the lithium carbonate sealer was applied to a non-copper containing zirconium-containing pretreatment, no improvement in adhesion was observed. However, when the two process modifications were combined, excellent adhesion was observed with zirconium-based pretreatments. This surprising result demonstrates the synergistic benefits of an adhesion promoter in the pretreatment composition and a lithium metal cation in the sealing composition.

### Example 6

### Metal Ion Carbonate/Anion Variation of Sealer Composition

Preparation of Alkaline Cleaner III:

A rectangular 316 stainless steel tank with a total volume of 100 liters including the filter system, equipped with spray nozzles, which deliver the cleaner solution at 20 psi was used to prepare cleaner III. The cleaner was formulated at a concentration of 1.0% v/v using 10 parts Chemkleen 2010LP (a phosphate-free alkaline cleaner available from Wuhan Caibao Surface Materials Co. LTD to 1 part of Chemkleen 181ALP (a phosphate-free blended surfactant additive available from PPG Industries, Inc.). The mass/volume of Chemekleem 2010 LP used was 1000 mL, Chemkleem 181ALF was 100 mL, and deionized water was 98.9 L. The cleaner was titrated in a manner as described for alkaline cleaner I. Alkaline cleaner III was used for Example 6.

Preparation of Pretreatment Compositions I-N:

Pretreatment composition I (PT-I) was prepared by the addition of 1.0% v/v of ZRCOZRF (density of material=1.3 g/mL, PPG Coatings, Zhangjiagang Co., Ltd.) to deionized water (1.04 kg of ZRCOZRF was added to 80 liters). This pretreatment bath was used for Example 6 with the bath levels being monitored and adjusted prior to each run. The copper level was adjusted using ZRCOCTRL1 (an aqueous solution of copper nitrate and nitric acid, PPG Coatings Zhangjiagang Co., Ltd.), pH was adjusted using BUF (an aqueous mixture of potassium hydroxide and sodium carbonate, Wuhan Caibao Surface Materials Co., Ltd.) the free fluoride was adjusted using Chemfos-AFL (an aqueous solution of ammonium bifluoride and potassium hydroxide, Wuhan Caibao Surface Materials Co., Ltd.), and the zirconium level was adjusted using ZRCOCTRL3 (an aqueous solution of hexafluorozirconic acid, PPG Coatings Zhangjiagang Co., Ltd.). After adjustment, each bath was assigned as PT-J, PT-K, PT-L, PT-M, and PT-N. The measured bath parameters are described in Table 24. Pretreatment bath parameters (pH, Cu, and free fluoride) were monitored in the same manner as for examples 1-5. The Zr concentration was monitored by using DR-890 Hach meter with Arsenazo-III dye as an indicator.

TABLE 24
Pretreatment Compositions Used in Example 6

| | | | | | Free | |
|---|---|---|---|---|---|---|
| Pretreatment | | Zr | Cu | | fluoride | Temperature |
| Composition | Code | (ppm) | (ppm) | pH | (ppm) | (° F.) |
| Bath-I | PT-I | 183 | 33.4 | 4.61 | 105 | 72.5 |
| Bath-J | PT-J | 180 | 31.3 | 4.52 | 116 | 75.7 |
| Bath-K | PT-K | 182 | 35.0 | 4.48 | 120 | 66.6 |
| Bath-L | PT-L | 180 | 33.8 | 4.58 | 118 | 67.3 |
| Bath-M | PT-M | 180 | 33.0 | 4.45 | 123 | 65.7 |
| Bath-N | PT-N | 181 | 31.1 | 4.50 | 106 | 68.5 |

Preparation of Sealing Compositions:

Each sealing composition bath was built by the addition of the metal-containing species listed in Table 25 below at the specified concentration to 30 liters of deionized water. The sealer composition was allowed to circulate prior to use. The sealer compositions were prepared using lithium carbonate (Tianjin Guangfu Fine Chemical Research Institute, Co., Ltd.), sodium carbonate (Tianjin Guangfu Fine Chemical Research Institute, Co., Ltd.), or potassium carbonate (available from Tianjin Baishi Chemical Industry Co., Ltd.). BUF was also used to build a sealing composition.

TABLE 25
Pretreatment Compositions used in Example 6

| | | Postrinse | Amount of Metal | Carbonate | pH of | Sealing Composition |
|---|---|---|---|---|---|---|
| Sealing | Metal | Level | Salt Added | Concentration | Sealing | Temperature |
| Composition | Salt | (ppm) | (g) | (ppm) | Composition | (° F.) |
| SC-10 | Li₂CO₃ | 250 | 7.5 | 203 | 10.80 | 72.5 |
| SC-11 | Li₂CO₃ | 1250 | 37.5 | 1015 | 11.07 | 75.7 |
| SC-12 | Li₂CO₃ | 2500 | 75.0 | 2030 | 11.14 | 66.6 |
| SC-13 | Na₂CO₃ | 359 | 10.8 | 203 | 10.75 | 67.3 |
| SC-14 | Na₂CO₃ | 3587 | 107.6 | 2030 | 11.07 | 67.3 |
| SC-15 | K₂CO₃ | 467 | 14.0 | 203 | 10.80 | 65.7 |
| SC-16 | K₂CO₃ | 4677 | 140.3 | 2030 | 11.25 | 65.7 |
| SC-17 | BUF | 350 | 18.7 | N/A | 10.99 | 75.7 |

Panel Preparation and Testing.

CRS and HDG test panels were obtained from ACT. The CRS product code was 28110 and the HDG product code was 53170. Control panels were prepared according to the pretreatment method L, as shown in Table 27 below, which included cleaning and pretreatment. Test panels with the novel sealer compositions were prepared in analogous manner to the control panels, but with substitution of the novel sealing composition instead of the second nitrite rinse. This procedure is detailed in pretreatment method M, as shown in Table 28 below. The specific pretreatment and sealer compositions tested are shown in Table 26. CRS panels were prepared according to the procedure described in method L or method M. HDG panels were prepared in the same way except the panels were sanded to form a bullseye defect prior to pretreatment process in the manner described in example 4.

The electrocoat used was ED7000ZC a 2K product available from PPG Coatings Co, Ltd. (Tianjin and Zhangjiagang, China) as a resin blend (E6433ZI) and a paste (E6433ZCI), which is diluted with deionized water. The material is ultrafiltered to 30%. The electrocoat was prepared in the following w/w ratio: 50.98% E6433ZI, 8.77% E6433ZCI, and 40.25% water. The electrocoat was applied with a DFT of 0.68-0.72 mils using 250 V at 90° F. for 190 seconds. The panels were baked at 170° C. for 32 minutes in an electric oven for 32 minutes to reach peak metal temperature for 20 minutes.

CRS panels were electrocoated, scribed and submitted to GM14872 cyclic corrosion testing for 26 cycles. HDG panels (with the bullseye defect) were pretreated, electrocoated, and rated for the appearance of the ridge around the sanded area (1-3). A rating of 1 was indicated poor performance with a clearly visible ridge mark. A rating of 2 was OK with a slightly visible ridge mark, 3 was good performance with no visible ridge mark.

TABLE 26
Pretreatment and Sealer Compositions used in Example 6

| | | | | | Bullseye |
|---|---|---|---|---|---|
| | Pre- | Sealing | | Corrosion | Mapping |
| | Treatment | Compo- | Treatment | Test on | Resistance |
| Condition | Composition | sition | Method | CRS | on HDG |
| Control | PT-N | None | Method L | Yes | Yes |
| 6A | PT-I | SC-10 | Method M | Yes | Yes |
| 6B | PT-J | SC-11 | Method M | Yes | Yes |
| 6C | PT-K | SC-12 | Method M | Yes | Yes |
| 6D | PT-L | SC-13 | Method M | Yes | Yes |
| 6E | PT-L | SC-14 | Method M | Yes | Yes |
| 6F | PT-M | SC-15 | Method M | Yes | Yes |
| 6G | PT-M | SC-16 | Method M | Yes | Yes |
| 6H | PT-N | SC-17 | Method M | No | Yes |

TABLE 27
Treatment Method L

| | |
|---|---|
| Step 1L | Spray Cleaner (60 seconds, 125° F.) |
| Step 2L | Immersion Cleaner (120 seconds, 125° F.) |
| Step 3L | City Water Rinse (60 seconds, ambient) |
| Step 4L | Nitrite Rinse 60 seconds, ambient) |
| Step 5L | Zirconium Pretreatment (120 seconds, immersion |
| | application, ambient) |
| Step 6L | Nitrite Rinse (60 seconds, ambient, spray application) |
| Step 7L | Deionized water rinse (60 seconds, immersion application, |
| | ambient) |
| Step 8L | Electric Oven Dry (60 seconds, 230 ° F.) |

TABLE 28
Treatment Method M

| | |
|---|---|
| Step 1M | Spray Cleaner (60 seconds, 125° F.) |
| Step 2M | Immersion Cleaner (120 seconds, 125° F.) |
| Step 3M | City Water Rinse (60 seconds, ambient) |
| Step 4M | Nitrite Rinse 60 seconds, ambient) |
| Step 5M | Zirconium Pretreatment (120 seconds, immersion |
| | application, ambient) |
| Step 6M | Sealing Composition (60 seconds, ambient, spray |
| | application) |
| Step 7M | Deionized water rinse (60 seconds, immersion |
| | application, ambient) |
| Step 8M | Electric Oven Dry (60 seconds, 230 ° F.) |

TABLE 29
Results of Corrosion Testing and Mapping Evaluation

| | | | GMW 14872 | | |
|---|---|---|---|---|---|
| | | | Corrosion | | |
| | | | Testing on CRS | | |
| | | | Avg. | Maximum. | Mapping |
| | Pre- | | Scribe | Scribe | Evaluation |
| | Treatment | Sealing | Creep | Creep | on HDG |
| Condition | Composition | Composition | (mm) | (mm) | (1-3)* |
| Control | PT-N | None | 2.80 | 4.67 | 1.8 |
| 6A | PT-I | SC-10 | 2.43 | 4.07 | 2.4 |
| 6B | PT-J | SC-11 | 2.47 | 3.80 | 2.7 |
| 6C | PT-K | SC-12 | 2.57 | 4.10 | 2.7 |
| 6D | PT-L | SC-13 | 2.53 | 3.83 | 2.7 |
| 6E | PT-L | SC-14 | 2.52 | 3.90 | 2.7 |
| 6F | PT-M | SC-15 | 2.53 | 3.97 | 2.7 |
| 6G | PT-M | SC-16 | 2.20 | 3.97 | 2.7 |
| 6H | PT-N | SC-17 | Not | Not | 2.7 |
| | | | Tested | Tested | |

The experimental sealer compositions evaluated in example 6 demonstrated the improvement in both corrosion resistance on CRS and reduction of bullseye ridge appearance on HDG. These data are shown in Table 29. Lithium carbonate, sodium carbonate, and potassium carbonate at various concentrations provide comparable corrosion resistance in GMW14872 testing with all experimental sealer compositions being superior to the control. The appearance of the ridge mark is also reduced with all of the alkali metal carbonates that were evaluated. Further, a mixture of hydroxide and carbonate (BUF) demonstrated better mapping performance. These results support the mechanism of the alkaline pH facilitating a fluoride/hydroxide metathesis (not a specific alkali metal carbonate) to reduce the concentration of fluoride in the deposited pretreatment film.

### Example 7

### The Effect of pH on Ridge Appearance

Preparation of Alkaline Cleaner IV:

This cleaner was prepared in a manner analogous to example 6 (cleaner III). To prepare alkaline cleaner IV, the mass/volume of Chemekleem 2010 LP used was 1000 mL, Chemkleem 181ALF was 100 mL, and deionized water was 98.9 liters. The cleaner was titrated in a manner as described for alkaline cleaner I. Alkaline cleaner IV was used for example 7.

Preparation of Pretreatment Composition O:

Pretreatment composition O (PT-O) was prepared by the addition of 1.0% v/v of ZRCOZRF (PPG Coatings Zhangjiagang Co, Ltd.) to deionized water (80 liters). This pretreatment bath was used for all of example 7. The bath levels were only initially monitored. The measured bath parameters are described in Table 30. Pretreatment bath parameters (pH, Cu, and free fluoride) were monitored in the same manner as for examples 1-5. The Zr level was monitored as described in example 6.

TABLE 30
Pretreatment Composition Used in Example 7

| | | | | | Free | |
|---|---|---|---|---|---|---|
| Pretreatment | | Zr | Cu | | fluoride | Temperature |
| Composition | Code | (ppm) | (ppm) | pH | (ppm) | (° F.) |
| Bath-O | PT-O | 180 | 20 | 4.52 | 100 | 73.8 |

Preparation of Sealing Compositions:

Each sealing composition bath was built by the addition of the lithium carbonate (Tianjin Guangfu Fine Chemical Research Institute, Co., Ltd.) to deionized water (30 liters). The sealer composition was allowed to circulate prior to use. The pH of each lithium carbonate sealer tested is displayed Table 31 as is the specific amount added. These sealing compositions were applied in the same manner as described in example 6.

TABLE 31
Sealer Compositions Used in Example 7

| | | | | | Sealing |
|---|---|---|---|---|---|
| | | | Amount | | Compo- |
| | | | of Metal | | sition |
| Sealing | | Postrinse | Salt | pH of | Temper- |
| Compo- | Metal | Level | Added | Sealing | ature |
| sition | Salt | (ppm) | (mg) | Composition | (° F.) |
| SC-18 | Li₂CO₃ | 0 | 0.0 | 5.89 | 73.8 |
| SC-19 | Li₂CO₃ | 0.6 | 18.0 | 8.0 | 73.8 |
| SC-20 | Li₂CO₃ | 0.8 | 24.0 | 8.5 | 73.8 |
| SC-21 | Li₂CO₃ | 1.3 | 39.0 | 9 | 73.8 |
| SC-22 | Li₂CO₃ | 10.3 | 309.0 | 10 | 73.8 |

Panel Preparation and Testing.

HDG panels were obtained from ACT as described in example 6. Panels were sanded, cleaned, pretreated, sealed, and electrocoated in the same manner as described in example 6 using treatment method M, as shown in Table 28. The specific pretreatment and sealer compositions tested are shown in Table 32. The appearance of the ridge mark on a sanded panel was evaluated as described in example 6.

TABLE 32
Pretreatment and Sealer Compositions used in Example 7

| | PreTreatment | Sealing | Treatment |
|---|---|---|---|
| Condition | Composition | Composition | Method |
| 7A | PT-O | SC-18 | Method M |
| 7B | PT-O | SC-19 | Method M |
| 7C | PT-O | SC-20 | Method M |
| 7D | PT-O | SC-21 | Method M |
| 7E | PT-O | SC-22 | Method M |

TABLE 33
Results of Corrosion Testing and Mapping Evaluation

| | | | | Mapping |
|---|---|---|---|---|
| | | | Sealer | Evaluation |
| | PreTreatment | Sealing | Composition | ofn HDG |
| Condition | Composition | Composition | pH | (1-3)** |
| 7A | PT-O | SC-18 | 5.89 | 1.7 |
| 7B | PT-O | SC-19 | 8.0 | 1.5 |
| 7C | PT-O | SC-20 | 8.5 | 2.0 |
| 7D | PT-O | SC-21 | 9 | 2.2 |
| 7E | PT-O | SC-22 | 10 | 2.7 |

**Average of two different panels with two measurement each.

Increasing the pH improved the mapping resistance on HDG with a pH greater than 10 demonstrating the most significant improvement over the deionized rinse. Table 33 shows the effect of pH on the reduction of the visibility of the ridge.

We claim:

1. A system for treating a substrate comprising:
a pretreatment composition for treating at a least a portion of the substrate, the pretreatment composition comprising a Group IVB metal cation; and
a sealing composition for treating at least a portion of the substrate treated with the pretreatment composition, the sealing composition comprising a Group IA metal cation.

2. The system of claim 1, wherein the Group IVB metal cation comprises zirconium, titanium, or combinations thereof.

3. The system of claim 1, wherein the Group IVB metal cation is present in an amount of 50 ppm to 500 ppm based on a total weight of the pretreatment composition.

4. The system of claim 1, wherein the pretreatment composition further comprises an electropositive metal ion present in an amount of 5 ppm to 100 ppm based on a total weight of the pretreatment composition.

5. The system of claim 1, wherein the pretreatment composition further comprises a lithium cation in an amount of 5 ppm to 250 ppm based on a total weight of the pretreatment composition.

6. The system of claim 1, wherein the pretreatment composition further comprises a molybdenum cation in an amount of 20 ppm to 200 ppm based on a total weight of the pretreatment composition.

7. The system of claim 1, wherein the pretreatment composition further comprises an adhesion promoter present in an amount of 10 ppm to 10,000 ppm based on a total weight of the pretreatment composition.

8. The system of claim 1, wherein the pretreatment composition has a free fluoride concentration of 5 ppm to 500 ppm based on a total weight of the pretreatment composition.

9. The system of claim 1, wherein the Group IA metal cation is present in the sealing composition in an amount of 5 ppm to 30,000 ppm based on a total weight of the sealing composition.

10. The system of claim 1, wherein the Group IA metal cation comprises lithium, sodium, potassium, rubidium, cesium, or combinations thereof.

11. The system of claim 1, wherein the sealing composition further comprises a carbonate, a hydroxide, or combinations thereof.

12. The system of claim 1, wherein the sealing composition has a pH of 8 to 13.

13. The system of claim 1, wherein the system is substantially free of phosphate.

14. A substrate treated with the system of claim 1.

15. The substrate of claim 14, wherein a fluoride content in a film deposited on a surface of the substrate by the pretreatment composition is no more than 10% fluoride.

16. The substrate of claim 14, wherein the substrate has a mean F-Zr ratio of 1:5 to 1:200.

17. The substrate of claim 14, wherein the substrate has a fluoride reduction factor of at least 2.

18. A method of treating a substrate comprising:
contacting at least a portion of the substrate surface with a pretreatment composition comprising a Group IVB metal cation; and
contacting at least a portion of the substrate surface with a sealing composition for treating at least a portion of the substrate treated with the pretreatment composition, comprising a Group IA metal cation; wherein the contacting with the pretreatment composition occurs prior to the contacting with the sealing composition.

19. The method of claim 18, wherein the substrate is rinsed with water prior to contacting with the sealing composition.

20. The method of claim 18, wherein the substrate is rinsed with water following the contacting with the sealing composition.

21. The method of claim 18, further comprising sanding at least a portion of the substrate surface; wherein the sanding occurs prior to contacting with the pretreatment composition.

22. A substrate treated according to the method of claim 21, wherein the sanded substrate surface treated according to the method has a reduction in b* value compared to a sanded substrate surface not treated with the sealing composition.

23. The substrate treated according to the method of claim 21, wherein the substrate has a Delta E reduced by 25% compared to a substrate not contacted with the sealing composition.
